(19) United States
(12) Patent Application Publication
(10) Pub. No.: US 2001/0003565 A1
(43) Pub. Date: Jun. 14, 2001

(54) DISPOSABLE APPLICATOR FOR SKIN CARE COMPOSITIONS

(76) Inventors: JOCELYN ELAINE MCOSKER, LOVELAND, OH (US); ASTRID ANNETTE SHEEHAN, CINCINNATI, OH (US); JAMES THOMAS SULLIVAN, CINCINNATI, OH (US); JEFFREY BRENT HAMNER, CINCINNATI, OH (US); RICHARD MICHAEL GIRARDOT, WEST CHESTER, OH (US); GENE MICHAEL ALTONEN, WEST CHESTER, OH (US); LYLE BROWN TUTHILL, WATERLOO (BE); CURTIS BOBBY MOTLEY, WEST CHESTER, OH (US)

Correspondence Address: THE PROCTER & GAMBLE COMPANY, PATENT DIVISION, SHARON WOODS TECHNICAL CENTER- BOX B22, 11450 GROOMS ROAD, CINCINNATI, OH, 45242, US

(21) Appl. No.: 09/370,396

(22) Filed: Aug. 6, 1999

Related U.S. Application Data
(63) Continuation-in-part of application No. 09/107,670, filed on Jun. 30, 1998, now abandoned.

(51) Int. Cl. B43K 5/14

(52) U.S. Cl. 401/132

(57) ABSTRACT

The present invention provides an applicator for applying and distributing a substance onto a target surface. The applicator comprises a substantially planar sheet of compressible, conformable material having opposed first and second surfaces and an interior region between said first and second surfaces. The sheet of material has a thickness between the first and second surfaces which decreases when the sheet of material is subjected to an externally-applied force in a direction substantially normal to the first surface. The applicator further includes at least one discrete reservoir extending inwardly of the first surface into the interior of the sheet of material which is at least partially filled with a substance and at least one discrete aperture formed in the first surface which is in fluid communication with the reservoir. Compression of the sheet of material via an externally-applied force substantially normal to said first surface expresses product from the aperture and translational motion of the first surface relative to a target surface applies and distributes said product onto the target surface. In a preferred embodiment, a plurality of apertures are associated with corresponding reservoirs forming a delivery zone near one end of a hand-held applicator, and the sheet material is preferably resilient both in compression and in bending to conform to irregular target surfaces. A wide variety of substances are contemplated, including particularly skin care compositions for skin that are susceptible to body exudates, moisture, or irritants. Other embodiments include a single reservoir feeding a plurality of apertures.

### CROSS REFERENCE TO RELATED APPLICATIONS

This is a continuation-in-part of co-pending U.S. patent application Ser. No. 09/185,785, filed in the name of Girardot et al. on Nov. 4, 1998, which is a continuation-in-part of U.S. patent application Ser. No. 09/187,670, filed in the name of Girardot et al. on Jun. 30, 1998, now abandoned.

### FIELD OF THE INVENTION

The present invention relates to applicators for use in manually applying coatings of a substance onto a desired target surface. More particularly, the present invention relates to such applicators which provide both dispensing and distribution functionality and therefore enhanced product performance.

### BACKGROUND OF THE INVENTION

There are many types of topical products that are commercially available and/or commonly applied to a desired (target) surface in the form of a thin film or coating to protect, treat, modify, etc. the target surface. Such products include those in the skin care, cosmetics, pharmaceutical, and other personal care arenas.

One common example of such a product is diaper rash treatment compositions, available commercially as topical creams, ointments, lotions or pastes. These compositions are applied to affected skin by hand to provide the occluded skin a barrier protection against direct contact with irritants in body exudates. There is a tendency to slather on a thick layer of the diaper rash composition, which is occlusive, messy, wasteful and aesthetically displeasing. Additionally, the excess cream/ointment may transfer to the absorbent article or other clothing such as undergarment, leading to reduced absorbency of the absorbent article or stained clothing. Moreover, topical treatment supplied via a multiple use container may develop bacterial growth and/or increase the incidences of cross-contamination among users.

Another common example of such a product is the antiperspirant/deodorant type of product, many of which are formulated as sprays, roll-on liquids, gels, creams, or solid sticks, and comprise an astringent material, e.g. zirconium or aluminum salts, incorporated into a suitable topical carrier. These products are designed to provide effective perspiration and odor control while also being cosmetically acceptable during and after application onto the axillary area or other areas of the skin.

Examples of suitable perforated caps or other shear force delivery means for use with such packaged compositions include those known in the art for application of creams, or those delivery means that are otherwise effective for delivering the composition of the present invention to the skin, with the resulting rheology of the extruded product preferably falling within the ranges described hereinabove for extruded compositions. Some examples of such perforated caps or other shear force delivery means, and some dispensing packages for use with compositions herein, are described in U.S. Pat. No. 5,000,356, issued to Johnson et al. on Mar. 19, 1991, which description is incorporated herein by reference.

While such delivery means have proven successful in applying such substances, in many instances a comparatively complex supply mechanism is required in order to dispense the product for application by shear force delivery means. This in turn typically requires a comparatively large canister to house not only the desired quantity of product but also the product retention and supply mechanism as well. Economic factors also typically require even travel size canisters for both elevator-type and push-up-stick packages to have considerable weight and occupy considerable volume, thus limiting the ability of the consumer to readily transport such devices. Moreover, such constructions for all practical considerations preclude the carrying of such devices on one's person such as in a pocket or modest-sized purse for replenishing application during the course of an extended stay away from home.

Accordingly, it would be desirable to provide a convenient, easily portable hand-held applicator for applying substances to target surfaces.

It would also be desirable to provide such an applicator which provides for a substantially uniform coating of such substances to yield aesthetically pleasing appearance and enhanced product performance.

It would also be desirable to provide such a disposable, single use applicator which is easy to use, leaves few noticeable residues on user's hands and avoids/minimizes contamination.

It would also be desirable to provide such an applicator which may be economically produced.

### SUMMARY OF THE INVENTION

The present invention provides an applicator for applying and distributing a substance onto a target surface. The applicator comprises a substantially planar sheet of compressible, conformable material having opposed first and second surfaces and an interior region between said first and second surfaces. The sheet of material has a thickness between the first and second surfaces which decreases when the sheet of material is subjected to an externally-applied force in a direction substantially normal to the first surface. The applicator further includes at least one discrete reservoir extending inwardly of the first surface into the interior of the sheet of material which is at least partially filled with a substance and at least one discrete aperture formed in the first surface which is in fluid communication with the reservoir. Compression of the sheet of material via an externally-applied force substantially normal to said first surface expresses product from the aperture and translational motion of the first surface relative to a target surface applies and distributes said product onto the target surface. In a preferred embodiment, a plurality of apertures are associated with corresponding reservoirs forming a delivery zone near one end of a hand-held applicator, and the sheet material is preferably resilient both in compression and in bending to conform to irregular target surfaces. A wide variety of substances are contemplated, including particularly skin care compositions for occluded or compromised skin. Other embodiments include a single reservoir feeding multiple apertures.

### BRIEF DESCRIPTION OF THE DRAWINGS

While the specification concludes with claims which particularly point out and distinctly claim the present invention, it is believed that the present invention will be better understood from the following description of preferred embodiments, taken in conjunction with the accompanying drawings, in which like reference numerals identify like elements and wherein:

FIG. 1 is a plan view of a preferred embodiment of an applicator in accordance with the present invention;

FIG. 2 is an elevational sectional view of the applicator of FIG. 1 taken along section line 2-2;

FIG. 3 is a schematic illustration of the applicator of FIGS. 1 and 2 being utilized to manually apply a coating of a substance to a target surface;

FIG. 4 is a plan view similar to FIG. 1 of another embodiment of an applicator;

FIG. 5 is an elevational sectional view similar to FIG. 2 of the applicator of FIG. 4 taken along section line 5-5.

FIG. 6 is a plan view similar to FIG. 1 of another embodiment of an applicator;

FIG. 7 is a plan view similar to FIG. 1 of another embodiment of an applicator; and

FIG. 8 is a plan view similar to FIG. 1 of another embodiment of an applicator.

### DETAILED DESCRIPTION OF THE INVENTION

1. Applicator Construction.

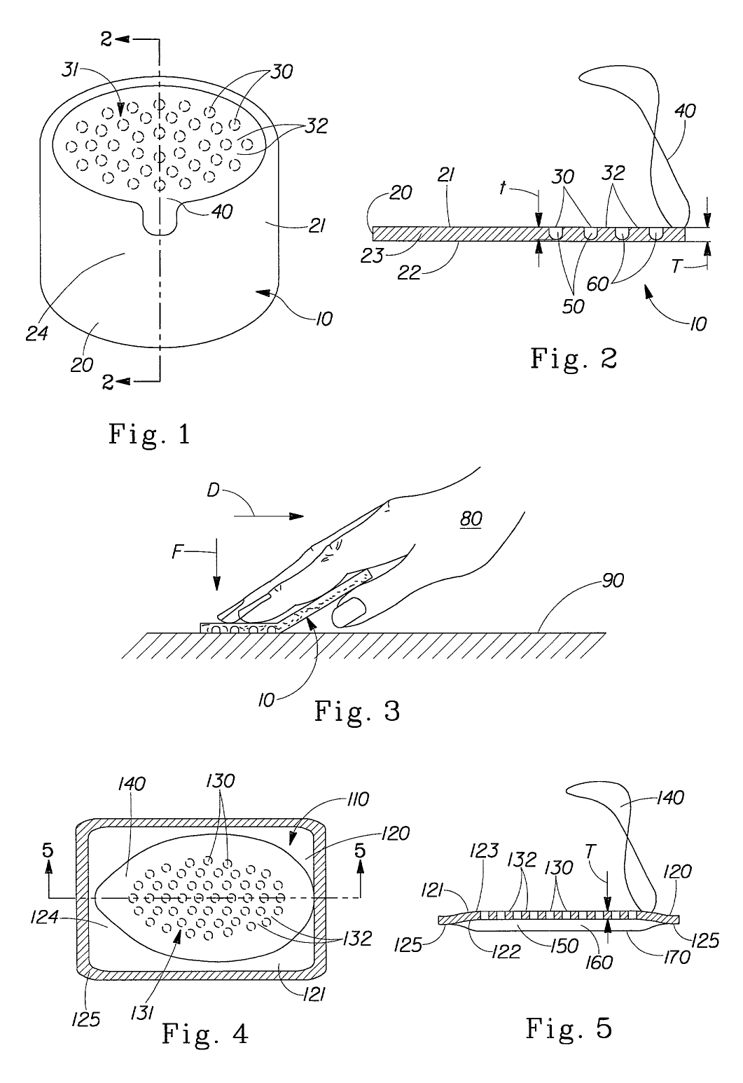

FIG. 1 depicts a preferred embodiment of an applicator 10 in accordance with the present invention. Applicator 10 comprises a substantially planar sheet of material 20 having a first side 21 and a second side 22, with the first and second sides defining an interior region 23 of the material 20. The first side 21 includes at least one aperture 30, and preferably a plurality of apertures 30 forming a delivery zone 31. The delivery zone 31 encompasses not only the apertures 30 but also the interstitial spaces 32 between adjacent apertures 30. As will be explained hereafter, the presence and construction of the interstitial spaces 32 are believed to play an important role in the distribution performance of the applicator 10 and in turn the performance of the substance distributed. In the embodiment shown in FIG. 1, the applicator 10 also includes an optional cover 40 releasably affixed to first side 21 so as to sealingly engage the first surface over and around the apertures 30 to occlude the apertures 30 and prevent premature dispensing or contamination of the product before the intended use. The cover may engage the first surface around the periphery of individual apertures or around the periphery of the delivery zone 31. Optional cover 40 may comprise a label with instructions or other suitable indicia thereon.

Second side 22 is preferably free of apertures and is preferably substantially planar, although for some applications it may be desirable to include some surface topography (such as a series of small protrusions coinciding with the locations of reservoirs 50) at least in the region underlying the delivery zone 31, to aid the user in orienting the applicator properly. The first surface also preferably includes a optional grasping portion 24 which is substantially free of apertures and is preferably located adjacent to one edge of the applicator. For some application configurations, it may be desirable to include a second delivery zone remotely from the first delivery zone, either elsewhere on the first surface or on the second surface of the applicator.

As shown more clearly in FIG. 2, the apertures 30 each extend inwardly of the first surface 21 into the interior 23 of the sheet of material 20 to form corresponding reservoirs 50 to contain a substance 60 prior to use. Suitable substances for use with the applicators of the present invention will be described in greater detail hereafter. Multiple substances may be employed in separate apertures and/or reservoirs, such that they remain segregated prior to applicator use but are co-mingled during use. This may be particularly useful wherein it is desired to prevent reactions between components prior to use and corresponding degradation or exhaustion of the active ingredients. Also, it may be desirable to include one or more “empty” apertures/reservoirs to either add air to the dispensed product and/or to act as a receiving reservoir to remove excess product from the target surface.

FIG. 2 also illustrates the geometrical relationship between the apertures 30, reservoirs 50, interstitial spaces 32, and the sheet material 20. The apertures, which may be of any desired size and shape, each have a peripheral edge which lies in the plane of the first surface 21 and defines the boundary of the aperture. In the instance where the sheet of material comprises a cellular structure, the apertures are substantially larger than the average cell size of the material. The interstitial spaces 32 are thus defined as the portion of the first surface 21 located between the peripheral edges of adjacent apertures. The reservoirs are located inwardly of the apertures and comprises a void within the interior of the sheet material. As with the apertures, the reservoirs are substantially larger than the average cell size of the material when the sheet of material is formed from a cellular structure. The reservoirs may or may not have the same cross-sectional shape in a direction parallel to the first surface 21 as that of the apertures 30. The sheet of material has an overall thickness T which is defined as the average distance between the opposing first and second surfaces 21 and 22 measured in a direction substantially normal to the first surface. In the instance wherein the surfaces are co-planar, the thickness T is perpendicular to both surfaces, and where non-planar surfaces are involved the planes of respective surfaces are defined as an average position of a representative plane passing through the surface topography.

The use of one or more discrete reservoirs as opposed to a generally porous substance-impregnated material, provides a more controlled dosing functionality for the applicators of the present invention. The reservoir geometry and volume may be designed as desired for ultimate capacity and also rate of delivery, whether in the preferred pre-loaded configuration where the applicator is manufactured and sold with the product included or where the applicator is manufactured independently of the product and the consumer applies the substance to the applicator.

In a given applicator, the delivery zone may include a plurality of apertures having differing sizes and/or shapes in either a regular pattern or an irregular pattern, and reservoirs need not also be filled to the same level or have the same capacity. Apertures can be of any desired cross-sectional shape at their intersection with the first surface, such as oval, elliptical, hexagonal, etc, but a circular cross-sectional shape is presently preferred.

The reservoirs 50 extend inwardly from the first surface to a depth t. Accordingly, since the reservoirs are formed as voids in the sheet of material 20, the material is a comparatively thick material on the order of at least about 0.063-0.250 inches as compared to forming reservoirs in thin embossed materials such as polymeric films. The sheet of material 20 is formed from a material which is sufficiently conformable to enable the first surface 21 to conform to irregular target surfaces, and is preferably resiliently conformable for application in a dynamic environment as the first surface passes over non-planar and irregular surfaces. The material utilized for the applicator is also deformable in the direction of thickness T to supply and deliver the substance 60 to the target surface for application and distribution. Deformation of the sheet of material 20 in such a manner effectively reduces the volume of the reservoirs 50 in the region of deformation, thus expressing the substance from the reservoirs outwardly through the apertures 30 into contact with the target surface.

Compressive deformation in the context of the present invention, as described herein, is defined as a reduction in the dimension T of the material by application of an external force (or otherwise) such that the first and second surfaces become closer together and the interior dimension between them becomes smaller. This is to be distinguished from other types of deformable structures wherein surfaces of the material or structure are translated or rotated relative to each other to reduce the effective thickness of the material. Such a thickness may be more appropriately characterized as “caliper” rather than “thickness”, as the “caliper” of such a material will be by definition greater than the “thickness” of the material from which it is made. An example of such a structure would be a three-dimensionally-embossed film which has a plurality of dimples or ribs formed therein. The film initially has a certain thickness or gauge, but after deformation out of the plane of the material the film has a caliper increase due to the dimensions of the ribs or dimples. Such a material may undergo a dimensional reduction in a plane normal to the plane of the material, but only via the deformation or destruction of the out-of-plane surfaces and structures. In structures and materials of the present invention, the caliper and thickness are substantially equivalent dimensions as any deviations from surface planarity in the vicinity of the delivery zone are insignificant. Accordingly, as the material itself compresses under the influence of an external force the first and second surfaces move toward one another without rotating or otherwise distorting the geometry of the sheet material.

Without wishing to be bound by theory, it is believed that the use of a comparatively thick substantially planar material with reservoirs formed into the material rather than the use of a comparatively thin material which is formed into a non-planar structure provides an applicator which allows application forces to be more uniformly transferred to the target surface for a more uniform substance distribution. This is particularly important when the applied forces may be more discretely applied, such as by one or more fingers spaced apart, as for most scenarios it is desired to not have the resulting product distribution mirror the pattern of the applied forces. For example, if one holds the applicator pad as shown in FIG. 3 it is desired to form a substantially uniform coating of the substance upon the target surface rather than four streaks of product corresponding to the location of the four fingers.

Another important characteristic for applicators of the present invention is the ability of the material to “glide” across the target surface without rolling up or otherwise becoming distorted. This also helps to ensure a comparatively even substance distribution on the target surface. Accordingly, selection of suitable applicator materials should account for not only the substance characteristics in terms of shear and other properties, but also the coefficient of friction of the material and the target surface.

The sheet material 20 may be unitary in nature, constructed from a single monolithic piece of material, or may comprise two or more layers or plies of material. In addition, it may be desirable to form the apertures and reservoirs in one layer of material, completely penetrating the sheet of material, and then laminating another layer of similar or diverse composition onto the second surface of the first piece of material to close the inward end of the reservoirs.

A presently preferred construction utilizes a polyethylene/EVA foam pad with multiple heat-embossed product reservoirs/apertures in one surface. However, a wide variety of other materials are contemplated as being within the scope of the present invention having suitable physical and/or chemical properties for the intended substance and intended target surface. The foam pad may be cut to the desired shape with a press and rule die, or other suitable means. The substance may be injected, doctored, or otherwise supplied to the reservoirs. The applicator may be of any desired size and shape, although the shape depicted in FIGS. 1-3 in dimensions of approximately 2.7″×2.4″×0.125″ thick has proven satisfactory in use, with 38 equally sized and spaced reservoirs forming an ellipse having an approximate major dimension of about 1.5 to 2.0 inches and a minor dimension of about 0.9 to 1.3 inches and delivering approximately 0.4 grams of antiperspirant composition (such as that described below). A presently preferred aperture size is between about 0.100 and about 0.150 inches in diameter, with a circular cross-section, an edge-to-edge spacing of between about 0.050 and about 0.110 inches, with a substantially straight-walled reservoir of similar cross-section extending inwardly therefrom.

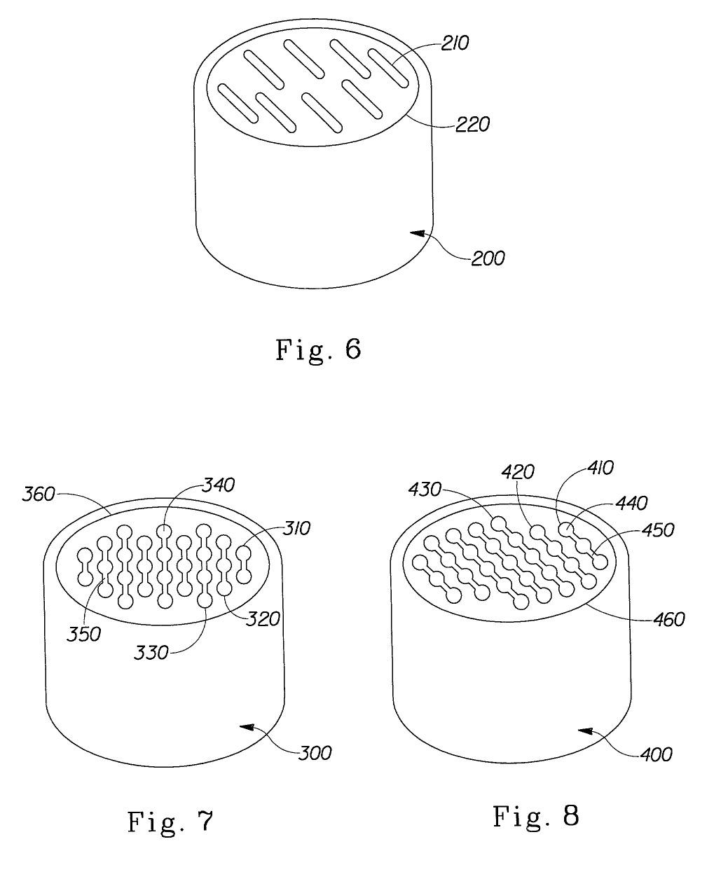

FIG. 6 depicts another embodiment of the present invention in the form of an applicator 200 having dimensions of approximately 2.7″×2.4″×0.125″ thick, which has proven satisfactory in use. Applicator 200 has 8 equally sized and spaced slot type reservoirs 210 positioned diagonally at 45° within an ellipse area 220 having an approximate major dimension of about 1.5 to 2.0 inches and a minor dimension of about 0.9 to 1.3 inches and delivering approximately 0.4 grams of antiperspirant composition (such as that described below). A presently preferred slot type reservoir 210 for applicator 200 has a length between about 0.578 and about 0.473 inches, a width between about 0.100 and about 0.080 inches, with a slot type cross-section with rounded ends, an edge-to-edge spacing between reservoirs 210 of between about 0.220 and about 0.080 inches, with a substantially straight-walled reservoir of similar cross-section extending inwardly therefrom between about 0.125 and about 0.080 inches in depth.

FIG. 7 depicts another embodiment of the present invention in the form of an applicator 300 having dimensions of approximately 2.7″×2.4″×0.125″ thick, which has proven satisfactory in use. Applicator 300 has 9 aperture-channel type reservoirs of varying configuration positioned within an ellipse area 360 having an approximate major dimension of about 1.5 to 2.0 inches and a minor dimension of about 0.9 to 1.3 inches and delivering approximately 0.4 grams of antiperspirant composition (such as that described below). Applicator 300 has a variation of: 2-aperture-channel reservoirs 310 having two apertures 340 connected by a single channel 350, 3-aperture-channel reservoirs 320 having three apertures 340 connected by two channels 350, and 4-aperture-channel reservoirs 330 having four apertures 340 connected by three channels 350. A presently preferred aperture 340 is between about 0.165 and about 0.135 inches in diameter, with a circular cross-section. A presently preferred channel 350 is between about 0.055 and about 0.045 inches in width, with a rectangular cross-section. A presently preferred spacing between the center of adjoining apertures 340 is between about 0.280 and about 0.200 inches in length. Edge-to-edge spacing between the apertures 340 is between about 0.095 and about 0.065 inches. Reservoirs are substantially straight-walled of similar cross-section extending inwardly therefrom between about 0.125 and about 0.080 inches in depth.

FIG. 8 depicts another embodiment of the present invention in the form of an applicator 400 having dimensions of approximately 2.7″×2.4″×0.125″ thick, which has proven satisfactory in use. Applicator 400 has 7 aperture-channel type reservoirs of varying configuration positioned diagonally at 45° within an ellipse area having an approximate major dimension of about 1.5 to 2.0 inches and a minor dimension of about 0.9 to 1.3 inches and delivering approximately 0.4 grams of antiperspirant composition (such as that described below). Applicator 400 has a variation of: 3-aperture-channel reservoirs 410 having three apertures 440 connected by two channels 450, 4-aperture-channel reservoirs 420 having four apertures 440 connected by three channels 450, and 5-aperture-channel reservoirs 430 having five apertures 440 connected by four channels 450. A presently preferred aperture 440 is between about 0.165 and about 0.135 inches in diameter, with a circular cross-section. A presently preferred channel 450 is between about 0.055 and about 0.045 inches in width, with a rectangular cross-section. A presently preferred spacing between the center of adjoining apertures 440 is between about 0.280 and about 0.200 inches in length. Edge-to-edge spacing between the apertures 440 is between about 0.095 and about 0.065 inches. Reservoirs are substantially straight-walled of similar cross-section extending inwardly therefrom between about 0.125 and about 0.080 inches in depth.

For a given product, an applicator design should be optimized to minimize premature dispensing and to maximize intentional-delivery of the desired product. A method which is believed to prevent premature dispensing of the desired product is to maximize the surface area of the reservoirs to which the product will adhere. The product typically has an affinity to the applicator surface; therefore, the product has a tendency to remain within the reservoirs. However, increasing the surface area of the reservoirs also decreases the amount of product that will be delivered intentionally later by the consumer. The propensity of the product to stay in the reservoir due to reservoir surface area, and the corresponding propensity of the product to be intentionally delivered by the consumer, are inversely related but not necessarily linearly proportional. Without wishing to be bound by theory, it is believed that as the surface area of a reservoir is increased for a constant reservoir volume and depth, there results a reduction in premature dispensing but also a corresponding, but not necessarily linearly, proportional reduction in intentionally-delivered product. Such theory may be discussed in reference to an aspect ratio defined and calculated as the [surface area of the reservoir]/[surface area of a cylindrical reservoir having an equal volume and depth]. It is believed that as the aspect ratio is increased, there results a reduction in premature dispensing but also a corresponding, but not necessarily linearly, proportional reduction in intentionally-delivered product. In determining the optimal applicator design for a given product, this aspect ratio may be used to compare various designs. For the embodiments illustrated in FIGS. 6, 7, and 8 such a method of optimization was utilized and it was found that an aspect ratio ranging from about 1 to about 5 has proven satisfactory in use for the products described herein.

As mentioned previously, it is presently preferred that the materials utilized in the present invention are not only compressible in the thickness direction but also conformable in the planar direction so as to accommodate various target surface topographies in use. It is also preferred that suitable sheet materials also be resilient, preferably both in terms of their compressibility and in terms of their bending conformability. Resilience is defined consistent with its everyday meaning, as evidenced by Webster's Ninth New Collegiate Dictionary, as “the capability of a strained body to recover its size and shape after deformation caused esp. by compressive stress.” Resilience of the material causes it to tend to return to its undeformed, preferably substantially planar state and original thickness after compressive or bending forces, thereby enabling it to conform to various target surfaces and yet maintain target surface contact for proper substance distribution.

Preferred material properties, as well as the properties of the presently preferred material, Volara 2E0 ⅛″ PE/EVA polyethylene/ethylene vinyl acetate copolymer (12%VA) fine-cell crosslinked polymer foam, commercially available from Voltek, 100 Shepard Street, Lawrence, Mass. 01843, are presented in the table below:

| | | | Preferred | |
|---|---|---|---|---|
| PROPERTIES | Volara 2EO 1/8″ | | Range | Test Method |
| Thickness in. | 0.125 | | 0.063-0.250 | ASTM D-3575 |
| Density lbs/cu ft. | 2 | nominal | 2-6 | ASTM D-3575 |
| Tensile Str psi (MD) | 55 | min. | 40-200 | ASTM D-3575 |
| Break Elongation % | 140 | min. | 100-350 | ASTM D-3575 |
| (MD) | | | | |
| Tear Resistance lb/ | 7 | min. | 4.5-30 | ASTM D-3575 |
| in(MD) | | | | |
| Compression Str. Psi | | | | |
| @25% deflection | 2.5 | min. | 1.5-15 | ASTM D-3575 |
| @50% deflection | 9 | min. | 4-25 | ASTM D-3575 |
| Compression set % | 30 | max. | 0-50 | ASTM D-3575 |

To quantify stiffness, a suitable method is TAPPI T489 om-92, Stiffness of paper and paperboard (Taber-type stiffness tester). Results are in gram centimeters or Taber units. Equipment used; Taber V-5 model 150B Stiffness Tester. Note: NO weight added and results measured at 15 degrees displacement.

| Actual Data: | Material 1/8″ caliper (Voltek#) | MD | | CD |
|---|---|---|---|---|
| | polyethylene (2A) | 65 | gm cm | 2 |
| | PE/EVA 12%VA (2EO) | 47 | | 34 |
| | PE/EVA 18%VA (2G) | 41 | | 32 |

Preferred limit range for ⅛″ thick, 2PCF foam are: MD testing=75-35 gram centimeters, CD testing=50-25 gram centimeters

While Volara 2EO is presently preferred material, alternate Volara grades and alternate foam materials such as open cell foam, non-crosslinked foam, foam with a range of cell sizes, alternate resins, 100% polyethylene, polystyrene, polypropylene, rubber, urethanes, other ethylene copolymers, propylene copolymers, and other synthetic materials having similar material properties could be used. Note, however, for some applications materials being substantially stiffer or softer may be preferred.

In the embodiment shown in FIGS. 1 and 2, the reservoirs have walls which are substantially normal to the first surface of the sheet of material. However, for certain product formulations of the substance to be delivered to the target surface it may be desirable to provide reservoir and aperture geometries wherein the reservoirs have sidewalls at angles other than 90 degrees, such as, for example, funnel-shaped tapered aperture/reservoir geometries wherein the reservoir narrows with increasing distance inwardly from the first surface or “undercut” aperture geometries where the reservoir widens with increasing distance inwardly from the first surface. Reservoirs may also be formed with substantially planar bottoms (the portion located distally from the apertures and within the interior of the sheet of material), or the bottoms of the reservoirs may be radiused, depending upon the manufacturing method of choice and the nature of the substances and sheet materials employed.

In addition, it is preferred that when the sheet of material comprises a porous material the reservoirs include some suitable means of preventing substance migration into the matrix of the sheet material. A presently preferred method of preventing such migration is to utilize a closed-cell foam material. However, such means may include an impermeable coating or may be some other means of rendering the reservoir walls impermeable such as thermally melting the porous sheet material during formation of the apertures and reservoirs to form a “skin”. Additional layers or coatings of polymers such as PET, nylon, etc. may be employed on the reservoir walls, the second side 21 of the applicator, or other regions where it is desired to limit substance penetration of the material. Any such treatments or approaches would be tailored to suit the particular combination of substance and applicator material(s). For some applications, it may also be desirable that the inner surfaces of the reservoir(s) and aperture(s) have some degree of surface topography to aid in anchoring the substance. Internal structures such as protrusions, “bosses”, peripheral rings, etc., may also be desirable to aid in substance retention. Various reservoir configurations may be employed without being limited to the aperture shape or the overall shape of the applicator, and may be tailored as desired to facilitate substance retention and/or dispensing.

FIG. 3 provides an illustration of an applicator 10 in accordance with the present invention being utilized to apply a substance to a target surface. As shown in FIG. 3, the applicator 10 is manually grasped by the hand 80 of a user, typically by pinching the applicator between the thumb and palm with the fingers contacting the second surface 22 in the vicinity of apertures 30 and the thumb contacting the grasping portion 24. The user then brings the delivery zone 31 of the applicator 10 into contact with a target surface 90, which may have any surface topography and may be planar or non-planar, and applies a force having at least a normal force vector component in a direction F which is substantially normal to the target surface 90. A tangential force or force vector component exerted in direction D is applied, preferably simultaneously with the application of normal force F, to move the applicator across the target surface 90 to apply a substantially uniform coating of the substance 60 to the target surface, preferably in a region substantially conforming to the scope of the delivery zone 31 and to the distance traveled. The normal and tangential forces may combine in such a manner as to define a total force vector which defines an angle between about 0 and about 90 degrees from the plane of the first surface. Such a manner of application provides for dispensing of the substance during the distribution phase of the process, rather than the typical extrusion or dispensing of substances followed by the distribution phase.

In a dynamic application environment such as that depicted in FIG. 3, in contrast with a “static” application scenario with no relative translational movement, it is believed that the relationship between the apertures (where a plurality are utilized) and the spaces between them is an important consideration in the design of suitable applicator geometries for particular substances. Each aperture has a peripheral edge which is surrounded by a portion of the first surface of the sheet material. As the sheet material, at least the first surface thereof, is preferably substantially planar, each aperture is thus surrounded by a substantially planar ring of material which contacts the target surface around the aperture and which provides a “rub-in” surface to distribute the substance on the target surface. Where the substance is or becomes flowable at the time of application, this ring of material forms a gasket-like surface which aids in uniformly distributing product by encouraging the outward flow of product from the apertures. Optionally, if desired a certain amount of surface texture, such as microtexture, may be applied to the portions of the first surface between and/or adjacent to the apertures to aid in the distribution function and/or the aesthetics of the application function in terms of skin feel, etc.

The applicators of the present invention depicted in FIGS. 1-3 have corresponding plural apertures and plural reservoirs, and preferably a 1:1 ratio of apertures to reservoirs. However, other combinations of apertures and reservoirs are also possible, such as multiple reservoirs supplying each aperture or multiple apertures supplied by a single reservoir. FIGS. 4 and 5 depict such an alternate embodiment. The applicator 10 of FIGS. 4 and 5 has a sheet of material 120 similar to the sheet of material 20 of FIGS. 1-3, but unlike the applicator 10 the applicator 110 has a plurality of apertures 130 which extend inwardly from the first surface 121 through the interior 123 of the sheet of material all the way through the second side 122, such that a completely unobstructed passageway is provided through the sheet of material 120. In such an embodiment, the sheet of material has a thickness T which is equivalent to the distance t (omitted for clarity). The apertures 130 form a delivery zone 131, are separated by interstitial spaces 132, and are preferably but optionally covered by a removable cover 140 which may have instructions or other suitable indicia thereon. The applicator 110 also includes a backing sheet 170 which is peripherally joined to the sheet of material 120 via a heat seal 125 or other suitable sealing technique, the backing sheet 170 cooperating with the seal 125, sheet of material 120, and cover 140 to form at least one, and preferably only one, reservoir 150 for containing a product 160 therein.

Another variation would include the use of a single large reservoir in an embodiment similar to that of FIG. 1, but including a plurality of “islands” protruding from the floor of the reservoir to provide a surface-contacting rub-in surface analogous to the network of interstitial spaces formed between multiple discrete apertures as shown in FIG. 1.

The apertures of the applicators of the present invention may be sealed prior to use in other ways than the use of a cover/label such as cover 40/140. For example, applicators may be sealed/bonded to one another in face-to-face or back-to-back relationship such that one surface of one applicator obstructs the apertures of the next. Other possible orientations include face-to-face orientations with delivery zones non-aligned and overlying other portions of the first surface, face-to-back, etc., and pairs of such materials can be packaged in a barrier film (foil laminate, metallized polyester, etc.) to form a convenient package.

The applicator of the present invention comprises a packaged delivery system having a shear force delivery means. Other examples of such delivery systems are well known in the art, and typically comprise an enclosed package or container having an attached shear force delivery means such as a perforated cap or other perforated surface. Shear force delivery means subject the delivered substance to shear forces which counteract the tendencies of the substance to agglomerate and/or remain in comparatively large or thick deposits and spread across the target surface. The application of shear force in combination with the substance delivery process is particularly important when the rheology and other product characteristics change under the influence of shear forces, such as the substance becoming more flowable under shear. Additional discussion of substance rheology follows hereafter.

Typical shear force delivery means include any ridged or flexible surface, preferably a ridged surface, suitable for attachment to a package or other product, and which has a plurality of openings, apertures or orifices extending through the thickness of the ridged or flexible surface through which the composition can flow to the intended site of application. However, in accordance with the present invention the applicators described herein provide delivery and distribution functionality meeting or exceeding that of other shear force delivery means in a convenient, economical, easy-to-use form.

2. Representative Compositions.

As used herein, the term “substance” means a composition suitable for being topically applied to a target or desired surface in the form of a thin film or coating to protect, treat, modify, etc. the target surface. The compositions suitable for use herein preferably are substantially non-flowing prior to delivery to a target surface. The compositions may be solid, semi-solid, or liquid. The compositions are capable of being held in open three-dimensional recesses of the applicator material in the absence of external forces other than those of gravity. Compositions which are substantially non-flowable prior to delivery are presently preferred. However, compositions which are flowable or have greater flowability may be found suitable for use in the present invention wherein overwraps, seals or the like provide for sufficient retention/protection of the compositions when not in use. Adhesives, electrostatics, mechanical interlocking, surface tension, capillary attraction, surface adsorption, van der Waals forces, and friction, for example, may be used to hold the compositions in the apertures and/or reservoirs. The compositions are intended to be at least partially released therefrom when exposed to contact with external surfaces when the applicator is subjected to externally-applied compressive forces. Of interest in the present invention include compositions in the form of gels, pastes, creams, lotions, foams, powders, agglomerated particles, prills, microencapsulated liquids, waxes, suspensions, liquids, and combinations thereof.

The spaces in the three dimensional structure of the present invention are normally open; therefore it is desirable to have the compositions stay in place and not run out of the structure without an activation step. Accordingly, the preferred compositions are capable of staying within the apertures and/or reservoirs even in the absence of an overwrap. The activation step utilized in accordance with the present invention is deformation of the three dimensional structure by compression, which overcomes the tendencies of the composition to remain within the applicator.

Preferred compositions include those which may be liberated from the applicator without the need for solvents (including water, etc.) in order to provide for a ready-to-use device. However, such preference should not preclude the use of otherwise suitable compositions merely because some degree of solvent use may be necessary. Suitable skin care compositions should perform satisfactorily and desirably in the absence of water.

### Skin Care Compositions for Occluded or Compromised Skin

A category of skin care compositions suitable for use in the applicator of the present invention are directed to skin conditions such as erythema, diaper dermatitis or diaper rash. These skin conditions are often found in skin areas such as perineum, buttocks, lower abdomen, and inner thighs, which may be caused by one or more of the following factors: moisture, occlusion, chafing, continued contact with urine, feces or their mixtures, or mechanical or chemical irritation. While these conditions are most common in infants, these skin conditions may also develop in other susceptible individuals who use absorbent articles for a certain period of time to tend to personal needs or health conditions, such as incontinence, menstruation, bed-ridden illness, or old age. As used herein the term “occluded skin” or “skin in diapered area” means skin in areas under an absorbent article when the article is worn. The absorbent articles include diapers, training pants, sanitary napkins, pantyliners, incontinence pads, etc. However, the present invention is also useful for “compromised skin” which is not limited to a particular area of the body. As used herein, the term “compromised skin” means skin that has been subjected to repeated or chronic exposures, or one or more acute episodes of exposure, to body exudates (urine, feces, blood, sweat, etc.), moisture, irritants, etc. such that the skin develops redness, chaffing, roughness, wrinkled appearance or itchiness. The present invention is also useful as a preventative measure for those susceptible skin areas. That is, the present invention may be applied to the susceptible skin before the skin is exposed to body exudates, moisture, irritants, etc. and/or before the skin becomes compromised.

The skin care composition is directed to maintain and/or improve the skin condition of the skin under an absorbent article or skin that is subjected to chronic or acute exposures to body exudates, moisture, irritants, etc. It is preferred that the skin care composition provides a protective, and preferably non-occlusive function (e.g., a relatively liquid impervious but vapor pervious barrier) to avoid skin overhydration and skin exposure to materials contained in body exudates (e.g., urine, feces, menstrual fluids). It is also preferable that the skin care composition provides an abrasion minimizing function to reduce skin irritation in the areas where the absorbent article is in contact with the wearer's skin. Additionally, the skin care composition may contain skin care ingredients which directly or indirectly, deliver skin care benefits, such as direct benefits of overhydration reduction, redness reduction or skin conditioning, and indirect of removal or reduction of skin irritants in body exudates. It is also preferred that the skin care composition contains emollients that protect or improve the skin condition against chaffing, roughness, wrinkled appearance or itchiness. The skin care composition may also contain skin soothing agents, such as aloe vera.

Skin care compositions suitable for use in the present invention are described in co-pending U.S. patent application Ser. Nos. 08/926,532 and 08/926,533, each filed on Sep. 10, 1997; in co-pending U.S. patent application Ser. Nos. 09/041,509, 09/041,232 and 09/041,266, each filed on Mar. 12, 1998; U.S. Pat. No. 5,607,760 issued Mar. 4, 1997; U.S. Pat. No. 5,609,587 issued Mar. 11, 1997; U.S. Pat. No. 5,635,191 issued Jun. 3, 1997; and U.S. Pat. No. 5,643,588 issued Jul. 1, 1997, the disclosures of which are hereby incorporated by reference.

### Emollients

For skin care compositions designed to provide skin protective and/or therapeutic benefits, a useful ingredient in these compositions is one or more skin protectants or emollients. As used herein, the term “emollient” is a material that protects against wetness or irritation, softens, soothes, supples, coats, lubricates, moisturizes, protects and/or cleanses the skin. In a preferred embodiment, these emollients will have either a plastic or liquid (i.e., substantially flowable) consistency at ambient temperatures, i.e., 20° C. Suitable emollient may be substantially anhydrous, that is, the emollients contain no ore than 10%, preferably no more than 5%, more preferably no more than 3% of water.

Representative emollients useful in the present invention include, but are not limited to, emollients that are petroleum-based; sucrose ester fatty acids; polyethylene glycol and derivatives thereof; humectants; fatty acid ester type; alkyl ethoxylate type; fatty acid ester ethoxylates; fatty alcohol type; polysiloxane type; propylene glycol and derivatives thereof; glycerine and derivatives thereof, including glyceride, acetoglycerides, and ethoxylated glycerides of C₁₂-C₂₈ fatty acids; triethylene glycol and derivatives thereof; spermaceti or other waxes; fatty acids; fatty alcohol ethers, particularly those having from 12 to 28 carbon atoms in their fatty chain, such as stearic acid; propoxylated fatty alcohols; other fatty esters of polyhydroxy alcohols; lanolin and its derivatives; kaolin and its derivatives; any of the monographed skin care agents listed above; or mixtures of these emollients. Suitable petroleum-based emollients include those hydrocarbons, or mixtures of hydrocarbons, having chain lengths of from 16 to 32 carbon atoms. Petroleum based hydrocarbons having these chain lengths include mineral oil (also known as “liquid petrolatum”) and petrolatum (also known as “mineral wax,” “petroleum jelly” and “mineral jelly”). Mineral oil is a mixture of various liquid hydrocarbons obtained by distilling the high boiling (i.e., 300-390° C.) fractions in petrolatum. Mineral oil is liquid at ambient temperatures, e.g., 20-25° C. Mineral oil usually refers to less viscous mixtures of hydrocarbons having from 16 to 20 carbon atoms. Petrolatum usually refers to more viscous mixtures of hydrocarbons having from 16 to 32 carbon atoms. Petrolatum and mineral oil are particularly preferred emollients for compositions of the present invention.

Suitable fatty acid ester type emollients include those derived from C₁₂-C₂₈ fatty acids, preferably C₁₆-C₂₂ saturated fatty acids, and short chain (C₁-C₈, preferably C₁-C₃) monohydric alcohols. Representative examples of such esters include methyl palmitate, methyl stearate, isopropyl laurate, isopropyl myristate, isopropyl palmitate, ethylhexyl palmitate and mixtures thereof. Suitable fatty acid ester emollients can also be derived from esters of longer chain fatty alcohols (C₁₂-C₂₈, preferably C₁₂-C₁₆) and shorter chain acids e.g., lactic acid, such as lauryl lactate and cetyl lactate.

Suitable alkyl ethoxylate type emollients include C₁₂-C₂₂ fatty alcohol ethoxylates having an average degree of ethoxylation of from about 2 to about 30. Preferably, the fatty alcohol ethoxylate emollient is selected from the group consisting of lauryl, cetyl, and stearyl ethoxylates, and mixtures thereof, having an average degree of ethoxylation ranging from about 2 to about 23. Representative examples of such alkyl ethoxylates include laureth-3 (a lauryl ethoxylate having an average degree of ethoxylation of 3), laureth-23 (a lauryl ethoxylate having an average degree of ethoxylation of 23), ceteth-10 (a cetyl alcohol ethoxylate having an average degree of ethoxylation of 10) and steareth-10 (a stearyl alcohol ethoxylate having an average degree of ethoxylation of 10). When employed, these alkyl ethoxylate emollients are typically used in combination with the petroleum-based emollients, such as petrolatum, at a weight ratio of alkyl ethoxylate emollient to petroleum-based emollient of from about 1:1 to about 1:5, preferably from about 1:2 to about 1:4.

Suitable fatty alcohol type emollients include C₁₂-C₂₂ fatty alcohols, preferably C₁₆-C₁₈ fatty alcohols. Representative examples include cetyl alcohol and stearyl alcohol, and mixtures thereof. When employed, these fatty alcohol emollients are typically used in combination with the petroleum-based emollients, such as petrolatum, at a weight ratio of fatty alcohol emollient to petroleum-based emollient of from about 1:1 to about 1:5, preferably from about 1:1 to about 1:2.

Other suitable types of emollients for use herein include polysiloxane compounds. In general, suitable polysiloxane materials for use in the present invention include those having monomeric siloxane units of the following structure:

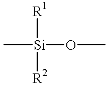

wherein, R¹ and R², for each independent siloxane monomeric unit can each independently be hydrogen or any alkyl, aryl, alkenyl, alkaryl, arakyl, cycloalkyl, halogenated hydrocarbon, or other radical. Any of such radicals can be substituted or unsubstituted. R¹ and R² radicals of any particular monomeric unit may differ from the corresponding functionalities of the next adjoining monomeric unit. Additionally, the polysiloxane can be either a straight chain, a branched chain or have a cyclic structure. The radicals R¹ and R² can additionally independently be other silaceous functionalities such as, but not limited to siloxanes, polysiloxanes, silanes, and polysilanes. The radicals R¹ and R² may contain any of a variety of organic functionalities including, for example, alcohol, carboxylic acid, phenyl, and amine functionalities.

Exemplary alkyl radicals are methyl, ethyl, propyl, butyl, pentyl, hexyl, octyl, decyl, octadecyl, and the like. Exemplary alkenyl radicals are vinyl, allyl, and the like. Exemplary aryl radicals are phenyl, diphenyl, naphthyl, and the like. Exemplary alkaryl radicals are toyl, xylyl, ethylphenyl, and the like. Exemplary aralkyl radicals are benzyl, alpha-phenylethyl, beta-phenylethyl, alpha-phenylbutyl, and the like. Exemplary cycloalkyl radicals are cyclobutyl, cyclopentyl, cyclohexyl, and the like. Exemplary halogenated hydrocarbon radicals are chloromethyl, bromoethyl, tetrafluorethyl, fluorethyl, trifluorethyl, trifluorotloyl, hexafluoroxylyl, and the like.

Viscosity of polysiloxanes useful for the present invention may vary as widely as the viscosity of polysiloxanes in general vary, so long as the polysiloxane is flowable or can be made to be flowable for application to the absorbent article. This includes, but is not limited to, viscosity as low as 5 centistokes (at 37° C. as measured by a glass viscometer) to about 20,000,000 centistokes. Preferably the polysiloxanes have a viscosity at 37° C. ranging from about 5 to about 5,000 centistokes, more preferably from about 5 to about 2,000 centistokes, most preferably from about 100 to about 1000 centistokes. High viscosity polysiloxanes which themselves are resistant to flowing can be effectively deposited upon the absorbent articles by such methods as, for example, emulsifying the polysiloxane in surfactant or providing the polysiloxane in solution with the aid of a solvent, such as hexane, listed for exemplary purposes only. Particular methods for applying polysiloxane emollients to absorbent articles are discussed in more detail hereinafter.

Preferred polysiloxanes compounds for use in the present invention are disclosed in U.S. Pat. No. 5,059,282 (Ampulski et al), issued Oct. 22, 1991, which is incorporated herein by reference. Particularly preferred polysiloxane compounds for use as emollients in the compositions of the present invention include phenyl-functional polymethylsiloxane compounds (e.g., Dow Coming 556 Cosmetic-Grade Fluid: polyphenylmethylsiloxane) and cetyl or stearyl functionalized dimethicones such as Dow 2502 and Dow 2503 polysiloxane liquids, respectively. In addition to such substitution with phenyl-functional or alkyl groups, effective substitution may be made with amino, carboxyl, hydroxyl, ether, polyether, aldehyde, ketone, amide, ester, and thiol groups. Of these effective substituent groups, the family of groups comprising phenyl, amino, alkyl, carboxyl, and hydroxyl groups are more preferred than the others; and phenyl-functional groups are most preferred.

Suitable fatty ester type emollients also include polyolpolyesters as described in U.S. Pat. No. 5,609,587, issued to Roe on Mar. 11, 1997, the disclosure of which is incorporated herein by reference. Exemplary polyols include, but are not limited to, polyhydric compounds such as pentaerythritol; sugars such as raffinose, maltodextrose, galactose, sucrose, glucose, xylose, fructose, maltose, lactose, mannose and erythrose; and sugar alcohols such as erythritol, xylitol, malitol, mannitol and sorbitol. Such polyols are esterified with fatty acids and/or other organic radicals having at least two carbon atoms and up to 30 carbon atoms. While it is not necessary that all of the hydroxyl groups of the polyol be esterified, preferred polyolpolyester emollients of the present invention have substantially all (e.g., at least about 85%) of the hydroxyl groups esterified. Particularly preferred are sucrose polyolpolyesters such as sucrose polycottonate, sucrose polysoyate, and sucrose polybehenate. Mixtures of such polyolpolyesters are also suitable emollients for the present invention.

Suitable humectants include glycerine, propylene glycol, sorbitol, trihydroxy stearin, and the like.

When present, the amount of emollient that can be included in the composition will depend on a variety of factors, including the particular emollient involved, the skin benefits desired, the other components in the composition and like factors. The composition will comprise from 0 to 100%, by total weight, of the emollient. Preferably, the composition will comprise from about 10 to about 95%, more preferably from about 20 to about 80%, and most preferably from about 40 to about 75%, by weight, of the emollient.

### Thickening Agents or Hardeners

Another optional, preferred component of the skin care compositions useful in the present invention is an agent capable of thickening the skin care composition in the reservoir of the applicator such that the skin care composition is substantially non-flowable when not subjected to externally applied forces (other than gravity). Because certain of the preferred emollients in the composition have a plastic or liquid consistency at ambient temperature (20° C.), they become flowable or exhibit improved flowability when subjected to even a modest compressive or shear force. To counteract the tendency of the emollient to flow, thickening agents may be added to provide the compositions with desired viscosity or product hardness. Not intending to be bound by theory, this is believed to be due, in part, to the fact that the thickening agent raises the viscosity and/or melting point of the skin care composition above that of the emollient.

The present invention also encompasses skin care compositions that are retained in the applicator by seals, overwraps, and the like, hence suitable skin care compositions may include low viscosity, flowable compositions, which have a small to nil amount of the thickening agents. Suitable compositions may also incorporate water, solvents and/or low melting emollients to reduce viscosity.

The thickening agent will preferably have a melting profile that will provide a composition that is solid or semisolid at ambient temperature so that the skin care compositions remain substantially non-flowable (i.e., immobilized) in the applicator and resist separation/segregation of components when not in use. In this regard, preferred thickening agents will have a melting point of at least about 35° C. so that the thickening agent itself will not have a tendency to migrate or flow. Preferred thickening agents will have melting points of at least about 40° C. Typically, the thickening agent will have a melting point in the range of from about 50° to about 150° C.

The skin care compositions should preferably be substantially uniform mixtures of components. Therefore, it is preferred to “lock” or “entrap” the emollients in the skin care composition. This can be accomplished by using thickening agents which quickly set up (i.e., thickening and/or solidify) in the reservoir of the applicator. In addition, outside cooling of the reservoir and/or the applicator via blowers, fans, cold rolls, etc. can speed up solidification (or crystallization) of the thickening agent. It is also preferred that the thickening agent is miscible with the emollient or is solubilized in the emollient with the aid of a suitable, optional emulsifier.

Thickening agents useful herein can be selected from any of a number of agents. Preferred thickening agents will comprise a member selected from the group consisting of C₁₄-C₂₂ fatty alcohols, C₁₂-C₂₂ fatty acids, and C₁₂-C₂₂ fatty alcohol ethoxylates having an average degree of ethoxylation ranging from 2 to about 30, and mixtures thereof. Preferred thickening agents include C₁₆-C₁₈ fatty alcohols, most preferably crystalline high melting materials selected from the group consisting of cetyl alcohol, stearyl alcohol, behenyl alcohol, and mixtures thereof. (The linear structure of these materials can speed up solidification). Mixtures of cetyl alcohol and stearyl alcohol are particularly preferred. Other preferred thickening agents include C₁₆-C₁₈ fatty acids, most preferably selected from the group consisting of palmitic acid, stearic acid, and mixtures thereof. Mixtures of palmitic acid and stearic acid are particularly preferred. Still other preferred thickening agents include C₁₆-C₁₈ fatty alcohol ethoxylates having an average degree of ethoxylation ranging from about 5 to about 20. Preferably, the fatty alcohols, fatty acids and fatty alcohols are linear. Importantly, these preferred thickening agents such as the C₁₆-C₁₈ fatty alcohols increase the rate of solidification of the composition, causing the composition to “set-up” (i.e., thicken or solidify) rapidly in the applicator/reservoir.

Other types of thickening agents that may be used herein include polyhydroxy fatty acid esters, polyhydroxy fatty acid amides, and mixtures thereof. Preferred esters and amides will have three or more free hydroxy groups on the polyhydroxy moiety and are typically nonionic in character. Because of the possible skin sensitivity of those using articles to which the composition is applied, these esters and amides should also be relatively mild and non-irritating to the skin.

Suitable polyhydroxy fatty acid esters for use in the present invention will have the formula:

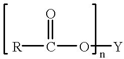

wherein R is a C₅-C₃₁ hydrocarbyl group, preferably straight chain C₇-C₁₉ alkyl or alkenyl, more preferably straight chain C₉-C₁₇ alkyl or alkenyl, most preferably straight chain C₁₁-C₁₇ alkyl or alkenyl, or mixture thereof; Y is a polyhydroxyhydrocarbyl moiety having a hydrocarbyl chain with at least 2 free hydroxyls directly connected to the chain; and n is at least 1. Suitable Y groups can be derived from polyols such as glycerol, pentaerythritol; sugars such as raffinose, maltodextrose, galactose, sucrose, glucose, xylose, fructose, maltose, lactose, mannose and erythrose; sugar alcohols such as erythritol, xylitol, malitol, mannitol and sorbitol; and anhydrides of sugar alcohols such as sorbitan.

One class of suitable polyhydroxy fatty acid esters for use in the present invention comprises certain sorbitan esters, preferably the sorbitan esters of C₁₆-C₂₂ saturated fatty acids. Because of the manner in which they are typically manufactured, these sorbitan esters usually comprise mixtures of mono-, di-, tri-, etc. esters. Representative examples of suitable sorbitan esters include sorbitan palmitates (e.g., SPAN 40), sorbitan stearates (e.g., SPAN 60), and sorbitan behenates, that comprise one or more of the mono-, di- and tri-ester versions of these sorbitan esters, e.g., sorbitan mono-, di- and tri-palmitate, sorbitan mono-, di- and tri-stearate, sorbitan mono-, di and tri-behenate, as well as mixed tallow fatty acid sorbitan mono-, di- and tri-esters. Mixtures of different sorbitan esters can also be used, such as sorbitan palmitates with sorbitan stearates. Particularly preferred sorbitan esters are the sorbitan stearates, typically as a mixture of mono-, di- and tri-esters (plus some tetraester) such as SPAN 60, and sorbitan stearates sold under the trade name GLYCOMUL-S by Lonza, Inc. Although these sorbitan esters typically contain mixtures of mono-, di- and tri-esters, plus some tetraester, the mono- and di-esters are usually the predominant species in these mixtures.

Another class of suitable polyhydroxy fatty acid esters for use in the present invention comprises certain glyceryl monoesters, preferably glyceryl monoesters of C₁₆-C₂₂ saturated fatty acids such as glyceryl monostearate, glyceryl monopalmitate, and glyceryl monobehenate. Again, like the sorbitan esters, glyceryl monoester mixtures will typically contain some di- and triester. However, such mixtures should contain predominantly the glyceryl monoester species to be useful in the present invention.

Another class of suitable polyhydroxy fatty acid esters for use in the present invention comprise certain sucrose fatty acid esters, preferably the C₁₂-C₂₂ saturated fatty acid esters of sucrose. Sucrose monoesters and diesters are particularly preferred and include sucrose mono- and di-stearate and sucrose mono- and di- laurate.

Suitable polyhydroxy fatty acid amides for use in the present invention will have the formula:

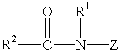

wherein R¹ is H, C₁-C₄ hydrocarbyl, 2-hydroxyethyl, 2-hydroxypropyl, methoxyethyl, methoxypropyl or a mixture thereof, preferably C₁-C₄ alkyl, methoxyethyl or methoxypropyl, more preferably C₁ or C₂ alkyl or methoxypropyl, most preferably C₁ alkyl (i.e., methyl) or methoxypropyl; and R² is a C₅-C₃₁ hydrocarbyl group, preferably straight chain C₇-C₁₉ alkyl or alkenyl, more preferably straight chain C₉-C₁₇ alkyl or alkenyl, most preferably straight chain C₁₁-C₁₇ alkyl or alkenyl, or mixture thereof; and Z is a polyhydroxyhydrocarbyl moiety having a linear hydrocarbyl chain with at least 3 hydroxyls directly connected to the chain. See U.S. Pat. No. 5,174,927 to Honsa, issued Dec. 29, 1992 (herein incorporated by reference) which discloses these polyhydroxy fatty acid amides, as well as their preparation.

The Z moiety preferably will be derived from a reducing sugar in a reductive amination reaction; most preferably glycityl. Suitable reducing sugars include glucose, fructose, maltose, lactose, galactose, mannose, and xylose. High dextrose corn syrup, high fructose corn syrup, and high maltose corn syrup can be utilized, as well as the individual sugars listed above. These corn syrups can yield mixtures of sugar components for the Z moiety.

The Z moiety preferably will be selected from the group consisting of —CH₂—(CHOH)ₙ—CH₂OH, —CH(CH₂OH)—[(CHOH)ₙ₋₁]—CH₂OH, —CH₂OH—CH₂—(CHOH)₂. (CHOR³)(CHOH)—CH₂OH, where n is an integer from 3 to 5, and R³ is H or a cyclic or aliphatic monosaccharide. Most preferred are the glycityls where n is 4, particularly —CH₂— (CHOH)₄—CH₂OH.

In the above formula, R¹ can be, for example, N-methyl, N-ethyl, N-propyl, N-isopropyl, N-butyl, N-2-hydroxyethyl, N-methoxypropyl or N-2-hydroxypropyl. R² can be selected to provide, for example, cocamides, stearamides, oleamides, lauramides, myristamides, capricamides, palmitamides, tallowamides, etc. The Z moiety can be 1-deoxyglucityl, 2-deoxyfructityl, 1-deoxymaltityl, 1-deoxylactityl, 1-deoxygalactityl, 1-deoxymannityl, 1-deoxymaltotriotityl, etc.

The most preferred polyhydroxy fatty acid amides have the general formula:

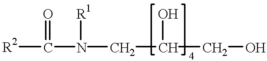

wherein R¹ is methyl or methoxypropyl; R² is a C₁₁-C₁₇ straight-chain alkyl or alkenyl group. These include N-lauryl-N-methyl glucamide, N-lauryl-N-methoxypropyl glucamide, N-cocoyl-N-methyl glucamide, N-cocoyl-N-methoxypropyl glucamide, N-palmityl-N-methoxypropyl glucamide, N-tallowyl-N-methyl glucamide, or N-tallowyl-N-methoxypropyl glucamide.

As previously noted, some of the thickening agents may require an emulsifier for solubilization in the emollient. This is particularly the case for certain of the glucamides such as the N-alkyl-N-methoxypropyl glucamides having hydrophilic lipophilic balance (HLB) values of at least about 7. Suitable emulsifiers will typically include those having HLB values below about 7. In this regard, the sorbitan esters previously described, such as the sorbitan stearates, having HLB values of about 4.9 or less have been found useful in solubilizing these glucamide thickening agents in petrolatum. Other suitable emulsifiers include steareth-2 (polyethylene glycol ethers of stearyl alcohol that conform to the formula CH₃(CH₂)₁₇(OCH₂CH₂)ₙOH, where n has an average value of 2), sorbitan tristearate, isosorbide laurate, and glyceryl monostearate. The emulsifier can be included in an amount sufficient to solubilize the thickening agent in the emollient such that a substantially homogeneous mixture is obtained. For example, an approximately 1:1 mixture of N-cocoyl-N-methyl glucamide and petrolatum that will normally not melt into a single phase mixture, will melt into a single phase mixture upon the addition of 20% of a 1:1 mixture of Steareth-2 and sorbitan tristearate as the emulsifier.

Other types of ingredients that can be used as thickening agents, either alone, or in combination with the above-mentioned thickening agents, include waxes such as camauba, ozokerite, beeswax, candelilla, paraffin, ceresin, esparto, ouricuri, rezowax, isoparaffin, and other known mined and mineral waxes. Higher melting waxes and/or higher crystallinity waxes (for example, more linear waxes) can help hardening the composition and resist separation/segregation of components dispersed therein. Additionally microcrystalline waxes are effective thickening agents. Microcrystalline waxes can aid in “locking” up components, such as low molecular weight hydrocarbons, within the skin care composition. Preferably the wax is a paraffin wax. An example of a particularly preferred alternate thickening agent is a paraffin wax such as Parrafin S.P. 434 from Strahl and Pitsch Inc., West Babylon, N.Y.

The amount of the optional thickening agent that can be included in the composition will depend on a variety of factors, including the emollients involved, the particular thickening agent involved, if any, the other components in the composition, whether an emulsifier is required to solubilize the thickening agent in the other components, and like factors. When present, the composition will typically comprise from about 5 to about 90% of the thickening agent. Preferably, the composition will comprise from about 5 to about 50%, most preferably from about 10 to about 40%, of the thickening agent.

### Skin Care Ingredients

The skin care compositions for use in the applicator of the present invention may optionally comprises various skin care ingredients which provide various skin benefits, such as reduction in redness, improvement in skin appearance and/or condition, formation of a barrier or protective layer, or reduction of irritants in body exudates. A host of skin care ingredients can be incorporated into the skin care compositions, which can be applied to the skin via a delivery system such as the applicator of the present invention. These ingredients include barrier substances (petrolatum), skin conditioning agents (oil, lanolin), proton donating agents, protease and/or enzyme inhibitors, and antimicrobials. The skin care composition may also contain humectants (glycerin, sorbitol), vitamins, skin soothing agents (such as aloe vera, or other ingredients of herbal, botanical or mineral origin), or multi-functional agents, such as zinc oxide. Generally, the skin care ingredients suitable for use herein provide skin condition benefits such as actual or perceived changes in appearance, cleanliness and attractiveness. The skin care ingredients may also include substances that soothe, calm, or promote feelings of relief when applied to the skin, e.g., the ingredients used in aromatherapy.

A wide variety of topically effective ingredients can be incorporated into the skin care composition of the present invention. When the composition is applied according to the present invention, the skin care ingredient can provide visible benefits to the condition of the occluded skin under an absorbent article or the compromised skin due to chronic exposures to hostile micro-environment. The skin care ingredients may be uniformly dispersed throughout the composition as insoluble particulates. Alternatively, the skin care ingredients may be solubilized in the substantially oleaginous composition of the present invention. The resultant composition is substantially stable (i.e., resistant to separation, coalescence, agglomeration, stratification and/or settling), has a consistency that renders it readily transferable to the skin, and is suitable for topical application to the skin via a delivery vehicle, such as the applicator described herein.

Numerous materials that have been deemed safe and effective skin care ingredients are logical materials for use herein. Such materials include Category I and Category III actives as defined by the U.S. Food and Drug Administration's (FDA) Tentative Final Monograph on Skin Protectant Drug Products for Over-the-Counter Human Use (21 C.F.R. § 347). It will be recognized that several of the monographed actives listed below are “emollients” as defined herein. Category I actives presently include: allantoin, aluminum hydroxide gel, calamine, cocoa butter, dimethicone, cod liver oil (in combination), glycerine, kaolin, petrolatum, lanolin, mineral oil, shark liver oil, white petrolatum, talc, topical starch, zinc acetate, zinc carbonate, zinc oxide, and the like. Category III actives presently include: live yeast cell derivatives, aldioxa, aluminum acetate, microporous cellulose, cholecalciferol, colloidal oatmeal, cysteine hydrochloride, dexpanthenol, Peruvean balsam oil, protein hydrolysates, racemic methionine, sodium bicarbonate, Vitamin A, and the like. These monographed materials are known to provide multiple skin benefits, such as skin protectant, itch prevention, irritation prevention, via various mechanisms.

The skin care ingredients suitable for the present invention may also include, but are not limited to, pH control agents or proton donating ingredients, such as pH buffer systems, ammonium-neutralizing agents, organic acids, polymeric acids, inorganic acids, and their salts; anti-microbials; enzyme inhibitors; protease inhibitors; anti-coenzymes; chelating agents; and anti-bodies. Some nonlimiting examples of proton donating agents are described in co-pending U.S. application Ser. No. 09/041,509, by McOsker et al. filed on Mar. 12, 1998, the disclosure of which is incorporated herein by reference.

Protease inhibitors can be divided into two general classes: the proteinases and the peptidases. Proteinases act on specific interior peptide bonds of proteins and peptidases act on peptide bonds adjacent to a free amino or carboxyl group on the end of a protein and thus cleave the protein from the outside. The protease inhibitors suitable for use in the present invention include, but are not limited to, proteinases such as serine proteases, metalloproteases, cysteine proteases, and aspartyl protease, and peptidases, such as carboxypepidases, dipeptidases and aminopepidases. Some non-limiting examples of such protease inhibitors are described in co-pending U.S. application Ser. No. 09/041,232, by Rourke et al filed on Mar. 12, 1998, U.S. Pat. No. 5,091,193 issued to Enjolras et al, on Feb. 25, 1992, and U.S. Pat. No. 4,556,560 issued to Buckingham on Dec. 3, 1985, all are incorporated by reference herein.

Enzyme inhibitors are designed to inhibit specific enzymatic activities of various classes of proteases. Specifically useful for the present invention are inhibitors that interact with those proteolytic and lipolytic enzymes commonly present in feces, such as lipases, esterases, diesterases, ureases, amylases, elastases, nucleases, The enzyme inhibitors suitable for use in the present invention include, but are not limited to, chelating agents which bind to metal cofactors of specific enzymes, antibodies raised for specific enzymes, enzyme inhibitors for various enzymes or coenzymes, preferably of the proteolytic type, such as trypsin, chymotrypsin, aminopeptidase and elastase, serine, cysteine, lipases, bile salts (acting as coenzymes that enhance the activities of lipases), amylases, and/or ureases. Other enzyme inhibitors known to effectively reduce or interfere with enzyme activities are also contemplated to be within the scope of the present invention. Some non-limiting examples of such enzyme inhibitors are described in co-pending U.S. application Ser. No. 09/041,266, by Roe et al. and U.S. application Ser. No. 09/041,196, by Underiner et al., both filed on Mar. 12, 1998, U.S. Pat. No. 5,376,655 issued to Imaki et al. on Dec. 27, 1994, U.S. Pat. No. 5,091,193 issued to Enjolras et al. on Feb. 25, 1992, U.S. Pat. No. 3,935,862 issued to Kraskin on Feb. 3, 1976, U.S. Pat. No. 5,409,903 issued to Polak et al. on Apr. 25, 1995, U.S. Pat. No. 4,556,560 issued to Buckingham on Dec. 3, 1985, Patent Application EP 97/120,699 and EP 97/120,700 both by Polumbo et al. and filed on Nov. 26, 1997, all are incorporated by reference herein.

The skin care ingredients in the present invention should preferably include at least one of the following: zinc oxide, talc, starch, allantoin, aloe vera, hexamidine and its salts and derivatives, hexamidine diisethionate, and its salts, triacetin, phytic acid, ethylenediamine tetraacetic acid (EDTA), phenylsulfonyl fluorides such as 4-(2-aminoethyl)-benzenesulfonylfluoride hydrochloride, chitosan, and mixtures thereof.

The skin care compositions suitable for the present invention may contain effective amounts of skin care ingredients. As used herein, the term “effective amount” of the skin care composition means an amount large enough to significantly or positively bring about the desired effect or to modify the condition to be treated such that the skin appears cleaner, more attractive or in better condition. The effective amount varies with the specific ingredient or composition used, the preventative or prophylactic effect desired, the type of condition or problem to be treated, the age and physical condition of the individual being treated, the severity of the condition to be treated, the intensity and duration of the treatment, and like factors. Typically, the skin care ingredients are present in a concentration of about 0.001% to about 70%, preferably about 0.01% to about 45%, more preferably about 0.1% to about 25%, and most preferably about 0.1% to about 10%, by weight of the skin care composition. The skin care ingredients may be used singly or as mixtures of ingredients. Because of the variety of skin care ingredients used in the present invention, the effective amount of each ingredient should be separately determined, as known to those skilled in the art.

### Suspending Agents

Another optional, preferred component of the skin care compositions useful for the present invention is the suspending agent, which is capable of suspending solids or liquids (e.g., skin care ingredients) dispersed in the compositions.

The suspending agents can be insoluble particles in the substantially oleaginous compositions of the present invention. These particulate suspending agents are typically in the form of finely divided, small particles having an average particle size of about 100 microns and a solubility in the composition of less than 10%, preferably less than 5% by weight. However, the particle size may vary depending on the type of agent, the mechanism to provide suspending effects, the activation (or formation of a rheological structure) of the suspending agent, and other like factors. It is recognized that the suspending agents may also be miscible or partially miscible with the other components in the compositions. It is also recognized that the suspending agents may be incorporated into the composition singly or as mixtures of various suspending agents.

The preparation and/or activation of the suspending agents may involve, but is not limited to, the following steps: reduction in agglomerates by milling, grinding, agitation or other methods known in the art; and activation by methods known in the art, such step being dependent upon the type of suspending agent used. As used herein, the term “activation” means the suspending agents undergo some chemical or physical changes to form a rheological structure which effectuates the changes in rheological properties of the compositions.

Some suspending agents may also function as thickening agents or hardeners to provide a solid or semi-solid composition at ambient temperature (i.e., about 20° C.) such that the composition is thickened to provide stability (such as maintaining non-flowability and resistance to separation/segregation when not in use). However, the resultant composition should not be so hardened as to interfere with its flowability and transferability to the skin when external forces are applied.

Non-limiting examples of suspending agents suitable for use herein are disclosed in co-pending U.S. patent application Ser. No. 09/316,691, filed by Gatto et al. on May 21, 1999, the disclosure of which is incorporated herein by reference.

### Type A Suspending Agents

A skin care composition modified by this type of suspending agent typically exhibits a substantially “flat” rheological profile with respect to temperature. Specifically, the apparent viscosity of the composition does not change substantially over the temperature range from about the processing temperature to room temperature. A thickening agent may be added when a substantially non-flowable (e.g., solid or semi-solid) composition at room temperature is desired.

A preferred suspending agent of this type for use herein is fumed silica, either surface-treated or untreated. Untreated fumed silica is available commercially under the trade name CAB-O-SIL M-5 and HS-5, from Cabot Corporation, Tuscola, Ill. More preferred for use herein is surface-treated fumed silica. Even more preferred is a fumed silica selected from the group consisting of polyalkylsiloxane treated fumed silica, trialkylsilanized fumed silica, dialkylsilanized fumed silica, and mixtures thereof.

Most preferred is a fumed silica selected from the group consisting of polydimethylsiloxane treated fumed silica, trimethylsilanized fumed silica, dimethyldisilanized fumed silica, and mixtures thereof. The fumed silicas typically have active hydroxyl groups, and it may be desirable to treat these fumed silicas such that the characteristics of the hydroxyl groups are altered. A useful method of treatment is to coat the fumed silicas with a nonpolar organic compound such as a polyalkylsiloxane, preferably a polydimethylsiloxane, to render the hydroxyl groups less active. A polydimethylsiloxane treated fumed silica useful herein is available commercially under the trade name CAB-O-SIL TS-720, by Cabot Corporation, Tuscola, Ill. Another useful method of treatment is to chemically react the hydroxyl groups of the fumed silica with a silanizing agent, e.g., dimethyldichlorosilane or hexamethyldisilizane. The chemically treated fumed silicas have the free hydroxyl groups replaced with an oxygen-silicon bond of the silanizing agent. A trimethylsilanized fumed silica useful herein is available commercially under the trade name CAB-O-SIL TS-530, and a dimethylsilanized fumed silica useful herein is available commercially under the trade name CAB-O-SIL TS-610, both by Cabot Corporation, Tuscola, Ill.

The fumed silica and treated fumed silica generally exist as agglomerates in the composition with a volume weighted average particle size of from about 0.001 micron to about 100 microns, preferably from about 0.005 micron to about 50 microns, and more preferably from about 0.01 microns to about 10 microns. The agglomerated configuration is the most efficient for interparticle interactions, which form the network structure that thickens and stabilizes the dispersion.

Also useful herein are organoclays, such as bentonites and hectorites that have been treated (i.e., coated) with various organic compounds to render the clays less polar. These organoclays are preferably made from a smectic clay platelet having a fatty chain organic compound bonded to its faces, and leaving the edges free to form hydrogen bonds. The fatty chains provide dispensability in the oleaginous medium, while the edge-to-edge hydrogen bonding of the platelets provides dispersion stability. Nonlimiting examples include quaternium-18 hectorites, stearalkonium hectorites, quaternium-18 bentonites, quaternium-18 benzalkonium bentonites, stearalkonium bentonites, and their mixtures with at least one member selected from the group consisting of with mineral oil, propylene carbonate, isopropyl palmitate, cyclomethicone, caster oil, lanolin, propylparaben, and C12-C15 alkyl benzoate. These organoclays or mixtures are available from Rheox, Inc., Hightstown, N.J., under the general trade names of BENTONE and BENTONE GEL. More preferred for use herein are BENTONE 38 (a quaternium-18 hectorite), BENTONE 27 (a stearalkonium hectorite), and BENTONE 34 (a quaternium-18 bentonite).

Metal fatty acid soaps are also useful herein. Specifically, useful herein are soaps made from the combination of at least one metal ion selected from the group consisting of aluminum, magnesium, zinc and lithium, and at least one fatty acid ester having a chain length of 10 to 28 carbon atoms, preferably of 12 to 22 carbon atoms, such as stearates, behenates, laurates and palmitates. More preferred for use herein are aluminum/magnesium hydroxide stearates, which are hydrophobic platelets formed from the complexation between stearic acid and aluminum/magnesium hydroxide in alternate layers. The platelet structure swells in the oil, thereby changes the rheological characteristics of the composition. Specifically, the viscosity of the composition is fairly constant over a broad temperature range. This allows for enhanced stability of the dispersion over the temperature range of the present invention. The aluminum/magnesium hydroxide stearate is available from Giulini Corporation, Bound Brook, N.J., under the general name of GILUGEL.

Also useful herein are calcium silicates and treated calcium silicates. Common forms of calcium silicates include CaSiO₃, CaSiO₄(OH)₂, CaSiO₅(OH)₄. The calcium silicates can be treated with a wide variety of nonpolar organic compounds to render the materials more hydrophobic and less reactive. Useful calcium silicates that are commercially available include the following: HUBERSORB (Huber Corp., Harve de Grace, Md.), and MICRO-CEL (Celite Corp., Denver, Colo.). Other silicates such as magnesium silicate, or magnesium/aluminum silicate are also useful herein.

Other nonlimiting examples also useful herein are suspending agents derived from natural sources, such as cholesterol and hydrogenated lecithin, and anionic surfactants such as DEA (diethanolamide) Oleth-3 phosphate.

### Type B Suspending Agents

A skin care composition modified by this type of suspending agent typically exhibits a temperature-dependent rheological profile. Specifically, the apparent viscosity of the composition increases as the temperature decreases from the processing temperature to room temperature. That is, Type B suspending agent functions like a thickening agent. Inclusion of a separate thickening agent to produce a substantially non-flowable composition at room temperature is optional when Type B suspending agent is used.

Useful herein are various organic derivatives of castor oil, such as THIXCIN R, THIXATROL ST, and the like. The principal constituent of these castor oil derivative is glyceryl tris-12-hydroxystearate. Various inorganic derivatives of castor oil are also useful herein, such as THIXCIN GR, THIXATROL GST, THIXSEAL 1084, and the like. All these castor oil derivatives or mixtures thereof are available from Rheox, Inc., Hightstown, N.J.

Also useful herein are polymeric suspending agents. Nonlimiting examples are polymethacrylates, methacrylate/styrene copolymers, which can optionally be crosslinked a common crosslinking agent, polyethylene, ethylene and acrylic acid or vinyl acetate copolymers, polyisobutylene, poly-α-olefins, bi or tri-component copolymers of styrene and ethylene, propylene, butylene, Nylon 66 and hydrophobic cellulose derivatives.

Also useful herein are nonionic surfactants. Nonlimiting examples include polyethylene oxide ethers derived from C₈-C₂₂ alcohols, preferably ceteth-10 (polyoxyethylene 10 cetyl ether), steareth-21 (polyoxyethylene stearyl ether) and mixtures thereof; ethoxylated or propoxylated alcohols or alkyl phenols, having preferably C₈-C₂₂ alkyl chains and preferably from about 6 to about 25 ethylene oxide or propylene oxide groups; mono- and di- fatty acid esters of ethylene glycol; fatty acid monoglyceride; sorbitan; mono- and di-C₈-C₂₂ fatty acids; polyoxyethylene sorbitan; and mixtures thereof.

Also useful herein are waxes such as carnauba, ozokerite, beeswax, candelilla, paraffin, ceresin, esparto, ouricuri, rezowax, isoparaffin, silicone waxes, polyethylene waxes, and other known mined and mineral waxes. Additionally microcrystalline waxes are also effective suspending agents. A preferred wax is a paraffin wax such as Paraffin S.P. 434 from Strahl and Pitsch Inc., West Babylon, N.Y.

Other nonlimiting examples also useful herein, without specific regard to the rheology-temperature profiles, are diethanlolamides; methylethylamides; and amphoteric surfactants such as dialkylamino propionic acid; alkyl galactomannan, zinc stearate, sorbitan sesquioleate, cetyl hydroxy ethyl cellulose and other modified celluloses.

The concentration and type of the suspending agent suitable for use herein will vary depending upon the desired product viscosity and/or hardness. The suspending agent typically comprises from about 0.1% to about 25% by weight of the skin care composition, preferably from about 0.25% to about 10% by weight, and more preferably from about 0.5% to about 5% by weight of the skin care composition.

### Optional Components

Compositions can comprise other components typically present in emulsions, creams, ointment, lotions, suspensions, etc. of this type. These components include water, surfactants, emulsifiers, disinfectants, antibacterial actives, antiviral agents, vitamins, pharmaceutical actives, film formers, perfumes, deodorants, opacifiers, astringents, solvents, preservatives, and the like. In addition, stabilizers can be added to enhance the shelf life of the composition such as cellulose derivatives, proteins and lecithin. All of these materials are well known in the art as additives for such formulations and can be employed in appropriate amounts in the compositions for use herein.

If water-based skin care compositions are used, emulsifiers may be added for solubilizing the thickening agents and/or suspending agents in the emollients. Suitable emulsifiers are typically hydrophilic surfactants, preferably mild and non-irritating to the skin. Typically, these hydrophilic surfactants are nonionic, such that they are non-irritating to the skin, and also avoid undesirable effects on any underlying tissue laminate structure. Suitable hydrophilic surfactants, nonionic or other types, are known in the art and may be incorporated in appropriate amounts in the compositions useful herein. A preferred surfactant is nonionic and preferably have an HLB value of from about 4 to about 25. Another preferred surfactant is an ethoxylated alcohol having an alkyl chain from about 8 to about 22 carbon atoms and having an average degree of ethoxylation ranging from about 2 to about 30. A particularly preferred surfactant is an ethoxylated sorbitan ester of a C12-C18 fatty acid having an average degree of ethoxylation of about 2 to about 20. Other nonlimiting examples of the surfactants are disclosed in U.S. Pat. No. 5,607,760 issued Mar. 4, 1997; U.S. Pat. No. 5,609,587 issued Mar. 11, 1997; U.S. Pat. No. 5,635,191 issued Jun. 3, 1997; and U.S. Pat. No. 5,643,588 issued Jul. 1, 1997, the disclosures of which are hereby incorporated by reference.

A preservative will also be needed for water-based skin care compositions. Suitable preservatives include propyl paraben, methyl paraben, benzyl alcohol, benzalkonium, tribasic calcium phosphate, BHT, or acids such as citric, tartaric, maleic, lactic, malic, benzoic, salicylic, and the like.

Suitable viscosity increasing agents include some of the agents described as effective thickening agents. Other suitable viscosity increasing agents include alkyl galactomannan, silica, talc, magnesium silicate, sorbitol, colloidal silicone dioxide, magnesium aluminum silicate, zinc stearate, wool wax alcohol, sorbiton, sesquioleate, cetyl hydroxy ethyl cellulose and other modified celluloses. Suitable solvents include propylene glycol, glycerine, cyclomethicone, polyethylene glycols, hexalene glycol, diol and multi-hydroxy based solvents. Suitable vitamins include A, D₃, E, B₅ and E acetate.

### Hardness, Viscosity and Melt Characteristics

As discussed further hereinafter, the preferred skin care compositions useful for the present invention will have a rheological profile such that they are substantially non-flowable when stored in the applicator, and yet are not completely liquid under stressful storage conditions. Preferably, the skin care compositions will become more flowable and easily transferable to the skin under a modest compressive or shear force, or even body heat. The skin care compositions should also preferably be stable (i.e., resistant to separation/segregation of components) under various storage conditions.

A preferred skin care composition for the present invention should be readily transferable to the skin by direct topical application. The composition should preferably be plastic or substantially flowable at skin temperature (i.e., about 34° C. to about 36° C.) to facilitate the transfer to the skin by providing additional glide, slip or lubrication. The composition should also be stable under various storage conditions (e.g., a “stressful” storage temperature of 45° C. or higher) in order to be substantially retained in the applicator and resist separation or segregation of the components when not in use (e.g., in transportation or storage). The compositions preferably are solid or semi-solid at ambient temperature (i.e., about 20° C.) so that they have the desired immobility, retainability or resistance to flow.

More flowable compositions are also suitable for use in the present invention wherein overwraps, seals, or the like provide for sufficient retention of the compositions in the reservoir or applicator when not in use.

The rheological profile of the skin care composition favorably provides sufficient liquid component at skin and/or body temperature, so that the composition glides more smoothly when applied to the skin and the composition is at least partially transferred to the skin. Not intending to be bound by theory, it is believed that transfer of the skin care composition to the skin is enhanced by the liquid component within the solid or semi-solid composition, possibly due to the flowability of the liquid component. It is also believed that the liquid component provides additional lubricating effect such that the composition glides over the skin more smoothly when topically applied to the skin.

Additionally, some rheological agents are in the form of fine solid particles in the skin care compositions which may further enhance the smooth skin feel or lubricity of the skin care composition. Not intending to be bound by theory, it is believed that some rheological agents, such as fumed silica particles, are very small spherical particles that tumble or roll under shear, thus providing additional lubricity when the composition is applied to the skin. It is also believed that some rheological agents, such as organoclays, have a laminar structure wherein the layers may slip under shear, thus providing additional smooth skin feel.

The viscosity of the compositions should be as high as needed to thicken or harden the compositions such that the compositions are substantially non-flowable and resistant to separation/segregation. However, too high a viscosity may inhibit the transferability of the composition to the skin. A balance should be achieved so the viscosities are high enough to provide the immobility/retainability and resistance to separation or segregation of the compositions, but not so high as to impede transfer to the skin.

Additionally, the compositions suitable for use herein preferably have a final melting point above potential “stressful” storage conditions that can be greater than 45° C. (e.g., warehouse in Arizona, car trunk in Florida, etc.). The melt profile of the composition can be determined by Differential Scanning Calorimetry (DSC) following manufacturer recommended standard operating procedures. Specifically, the compositions suitable for use herein preferably have the following melt profile:

| Characteristic | Preferred Range | Most Preferred |
|---|---|---|
| % liquid* at | 2-50 | 15-35 |
| room temp. (20° C.) | | |
| % liquid* at | 25-95 | 30-90 |
| body temp. (37° C.) | | |
| final melting point (° C.) | ≧38 | ≧45 |

*wt % of the composition excluding insoluble particles (e.g., certain skin care ingredients or rheological agents).

Preferred compositions are at least semi-solid at room temperature for transferability, retainability (i.e., resistance to flow when not in use) and stability (i.e., resistance to separation/segregation of components). In a preferred embodiment, the skin care compositions useful herein are solid, or semi-solid at ambient temperature, i.e., at 20° C. The term “semisolid”, as used herein, means that the composition has a rheology typical of pseudoplastic or plastic liquids. When no shear is applied, the composition can have the appearance of an immobile solid, but the composition can be made to flow as the applied force is increased. This rheological characteristic may also be due to the thickening agents and/or the suspending agents in the compositions. Preferably, the compositions of the present invention have a zero shear viscosity between about 5.0×10⁵ centipoise and about 1.0×10⁸ centipoise. More preferably, the zero shear viscosity is between about 1.0×10⁶ centipoise and about 5.0×10⁷ centipoise.

Hardness is measured using a Texture Technologies TA.XT2I Texture Analyzer (5 Kg capacity and 0.1 g force resolution) and associated Windows software, Texture Expert Exceed from Stable Micro Systems, LTD. The Texture Analyzer is fitted with a ¼inch Stainless Steel Spherical Probe; TA-8 from Texture Technologies is a suitable probe that was used for these tests. The skin care composition to be tested is prepared by mixing the components using technology known in the art. A cylindrical canister is filled to the top edge with the skin care composition and the top surface is scraped with a spetula and/or rubbing against a flat substrate to create a smooth surface for analysis. The filled canister is positioned under the ¼inch spherical probe and the probe is lowered such that it just contacts the surface of the composition in the casing. The probe is then moved downward into the sample at a constant rate of 0.1 mm/sec, while measuring force and distance. Probe travel is stopped when a penetration depth of 7 millimeters is attained. “Hardness” is defined as the maximum resistive force encountered by the probe in the 7 millimeter stroke and is expressed in “grams”. The temperature of the room and the composition should be maintained at about 65-75° F. during the course of the measurement.

Hardness has been found to relate strongly to the complex modulus of the material, which is a combination of the viscous and elastic moduli of the material. Therefore, hardness data described herein is a good indicator of transferability as well as product integrity/storage stability at ambient temperature. The skin care composition of the present invention preferably has a hardness of about 50 gm to about 1000 gm, preferably from about 60 gm to about 800 gm, more preferably from about 70 gm to about 400 gm.

The skin care compositions suitable for use herein are characterized by a combination of rheological parameters: the delta stress and the static yield stress. These rheological characteristics are determined by the general methodology described in detail hereinafter, at 27° C., 15% relative humidity, unless otherwise specified.

To determine delta stress and static stress yield values for the skin care compositions, the compositions are analyzed using a Rheometrics Dynamic Stress Rheometer (available from Rheometrics Inc., Piscatawany, N.J., U.S.A) with data collection and analysis performed using Rhios software 4.2.2 (also available from Rheometrics Inc., Piscatawany, N.J., U.S.A.). The rheometer is configured in a parallel plate design using a 25 mm upper plate (available as part number LS-PELT-IP25 from Rheometrics Inc., Piscatawany, N.J., U.S.A.). Temperature control is set at 37° C. Analysis of the skin care composition is performed in the “Stress Sweep: steady sweep” default test mode. Rheometer settings are initial stress (1.0 dyne/cm²), final stress (63,930 dyne/cm²), stress increment (100 dyne/cm²), and maximum time per data point (5 seconds).

The term “static yield stress” as used herein refers to the minimum amount of stress (dyne/cm²) that must be applied to the composition to move the upper plate of the Rheometrics Dynamic Stress Rheometer a distance of about 4.2 micro radians, in accordance with the analysis methods described herein. In other words, static yield stress represents the point in a stress sweep analysis (described herein) of a product at which point the rheometer is first capable of measuring product viscosity.

The term “delta stress” as used herein is determined by subtracting the static yield stress from the dynamic yield stress of a composition. The dynamic yield stress is the point at which the measured viscosity begins to rapidly decline. This can be easily determined by finding the last stress value where the increment between stress values is 100 dynes/cm². In other words, the delta stress of the composition represents the incremental amount of stress that must be applied to the composition, beyond the static yield stress of the composition, to substantially liquefy the composition.

The skin care composition is evaluated for rheology characteristics after the composition has been packaged in the applicator device of the present invention. A section of the composition is carefully removed from the applicator so that the product is subjected to minimal shear, and especially so that it is not permitted to curl or otherwise reconfigure to a shape other than that of the section as it was removed from the composition. The section is carefully placed flat on the lower plate of the rheometer, taking care to minimize the application of shear stress on the section during the placement. The area of the placed section is at least about the size of the upper plate to assure proper contact between the two plates during testing. The upper plate is then lowered toward the bottom plate, and positioned about 2 mm above the lower plate, and therefore about 1 mm from the product section which is positioned flat on the lower plate. The upper plate is further lowered at a minimal rate toward the lower plate, and positioned about 1.000 (±0.002) mm above the lower plate, at which point the product is gently positioned between and contacting each of the lower and upper plates. Excess product extending away from and around the parallel positioned plates is gently removed using a spatula, and taking care to subject the product positioned between plates to minimal or no further shear from the spatula. The solvent guard pad on the rheometer is saturated with the type of liquid carrier corresponding to that in the test product. The solvent guard is lowered over the parallel plates to prevent solvent loss from the test product that is positioned between the plates during analysis. The product is now ready for rheology analysis and determination of dynamic stress, static yield stress, and delta stress.

Product samples are subjected to rheological test and evaluation in accordance with the above described methodology. Data from the above described analysis can be plotted as viscosity (pascal.sec.) on a log scale versus linear applied stress (dyne/cm²). The initial point at which the instrument measures a viscosity is the static yield stress (i.e. the lowest stress at which the instrument shows a non-zero viscosity). The dynamic yield stress is the point at which the measured viscosity begins to rapidly decline. This can be easily determined by finding the last stress value where the increment between stress values is 100 dyne/cm². The delta stress is then determined by subtracting the static yield stress from the dynamic yield stress.

The skin care compositions suitable for use herein have a static yield stress value of at least about 4,000 dyne/cm², preferably at least about 8,000 dyne/cm², and more preferably at least about 40,000 dyne/cm². The maximum static yield stress values for the compositions is preferably less than about 120,000 dyne/cm², more preferably less than about 63,000 dyne/cm².

The delta stress value of the skin care compositions is from about 300 dyne/cm² to about 8,000 dyne/cm², preferably from about 1,000 dyne/cm² to about 6,000 dyne/cm², more preferably from about 1,000 dyne/cm² to about 5,000 dyne/cm². A delta stress below the minimum level can result in syneresis during shear force delivery means, whereas a value above the recited maximum can result in nonuniform spreading of the product onto the skin, and reduced spreadability on the skin, especially on hairy areas of the skin. The delta stress values, therefore, recited herein provide for a smooth creamy product that shows minimal or no solvent syneresis, and spreads uniformly over the skin, and spreads especially well over and through hairy areas of the skin.

Where seals or overwraps are used, lower viscosity, flowable skin care compositions are also suitable for use in the present invention. Viscosity for the composition may be as low as 1 centipoise (i.e., equivalent to the viscosity of water). Suitable viscosity will typically range from about 5 to about 500 centipoise, preferably from about 5 to about 300 centipoise, more preferably from about 5 to about 100 centipoise, measured by a rotational viscometer (a suitable viscometer is available from Lab Line Instruments, Inc. of Melrose Park, Ill as Model 4537), which is operated at 60 rpm using a number 2 spindle.

### Other Compositions

While much of the foregoing discussion has focused upon particular compositions such as skin care compositions for occluded or compromised skin which have proven suitable for use with applicators according to the present invention, it should be understood that the principles of the present invention are believed to apply to other applicator/composition combinations wherein the applicator is designed to account for the particular characteristics of the composition and the nature of the application environment. For example, it is believed that other compositions such as sunscreens, cooking products such as fats, oils, and shortenings, waxes such as shoe polishes and the like, and other compositions may be suitable for use with applicators as described herein.

In accordance with the present invention, the composition utilized in combination with the deformable material exhibits a selection of physical properties which enable it to be dispensed from its protected orientation within the three-dimensional structure and applied to the target surface. Such dispensation may be partial, or substantially or totally complete in nature.

To facilitate such dispensing, composition properties which are believed to be important include the relative affinity of the composition for the target surface versus that for the deformable material and the apparent viscosity or flowability of the composition after activation of the three-dimensional structure. It is presently believed that the composition should preferentially adhere to the target surface to a greater extent than to the deformable material and/or to a greater extent than for other portions of the composition itself. Said differently, the composition has a greater affinity for the target surface than for itself and/or for the deformable sheet material.

Compositions may inherently possess viscosity and flow characteristics which permit their liberation from their protected location within the sheet material or may require viscosity modification to permit liberation and dispersal. Viscosity modification may be obtained by the selection of compositions which undergo a change in viscosity in response to the mode of activation selected. For example, for a mechanical activation such as a compressive force it may be desirable, and preferably, to employ compositions which are commonly referred to as “shear-thinning” (pseudoplastic) compositions. Examples of such compositions include polymer solutions, many gels and pastes such as dentrifice and body creams, paints, gelled wood stains, etc. Other materials behave as shear-thinning materials only after a certain threshold shear (yield stress) is reached or exceeded. Such materials are commonly referred to as Bingham plastic materials, and one common example of a composition exhibiting such behavior is the type of condiment known as ketchup.

Some of the factors believed to influence the adhesion or affinity of the composition for the target surface include: electrostatic or electrical charges; chemical bonds via hydrogen bonding, covalent bonding, ionic bonding, partial ionic bonds (partial dipolar attraction), van der Walls forces, osmotic forces, etc.; capillary pressure (suction); adsorption; absorption; vacuum/suction; etc. Other important factors include the wettability of the composition upon the target surface, as reflected by the contact angle of the composition on the target surface.

To facilitate spreading or dispersal of the composition upon the target surface, particularly to counteract the tendency of the composition to remain in a localized distribution pattern given the localized orientation upon the deformable composition, it is presently preferred to utilize compositions which are tailored so as to be wettable on the target surface. Other factors which may aid in dispersion or distribution of the composition upon the target surface include the use of compositions which exhibit a shear-thinning behavior, as well as mechanical spreading action provided by the user of the composite sheet material to impart a lateral mechanical motion after activation but prior to removal of the deformable material from the target surface. Such lateral mechanical action may also provide additional interaction with the composition such as for shear-thinning compositions and may provide additional benefits such as lathering, foam generation, scrubbing/abrasive action, etc.

Successful dispersal occurs when a portion of the deposited or dispensed composition subsequently coats a portion of the target surface where the composition was not originally deposited. Upon removal of the sheet material from the target surface, at least some of the composition remains located on the target surface, preferably in a substantially-uniform fashion.

As discussed above, a wide variety of compositions may be selected for use in accordance with the principles of the present invention. Representative compositions for illustrative purposes include cleansing agents such as soaps and detergents, emollients such as lotions, medicinal agents such as ointments, anti-inflammatory creams, etc., health and beauty care products, including antiperspirants, deodorants, cosmetics, fragrances, and the like. Other more diverse applications for such a sheet material include applicators for automotive and household products such as lubricants, colorants, protectants such as oils and waxes, adhesives, preservatives, and the like, as well as food-oriented applications such as condiments (mustard, ketchup, etc.).

Multiple compositions may also be employed which are not only protected from inadvertent contact but segregated from one another initially (on the same face of, or on opposing faces of, the sheet material) and be commingled during the activation process or during subsequent dispensing and/or dispersion operations. Such an arrangement may be particularly useful for compositions which beneficially interact with one another (e.g., co-dispensing epoxies, catalyzed reactions, etc.) to provide additional functionality with each other and/or with the target surface. It may also be desirable to provide for progressive or sequential composition delivery by tailoring the geometry of the applicator or composition properties to provide for initial application followed by additional progressive dispensing with the passage of time, increased pressure, etc.

Some compositions may contain oxidatively unstable or photo-degradable ingredients. Special seals or overwraps may be used to prevent or minimize oxidation or photodegradation, in addition to optional stabilizers in the compositions.

3. Methods of Manufacture.

The applicators of the present invention may be manufactured in any manner suitable for the intended geometry and intended materials and compositions involved. By way of example, for the presently preferred foam materials articulated above, the configuration of FIG. 1 may be manufactured by forming the plurality of apertures and reservoirs via thermal embossing with a heated die to the desired depth, then either injecting the composition into the reservoirs or flooding the composition into/onto the applicator and doctoring off the excess composition. A label or seal is then applied over the delivery zone and secured by thermal or adhesive means. The applicator may then be die cut to the final shape, or alternatively the die cutting step may be accomplished at the same time as the formation of the reservoirs, or any other suitable arrangement of steps. The composition may be heated or otherwise made flowable for such a process if necessary.

For an embodiment with a single reservoir such as that of FIG. 4, the application surface may be similarly manufactured, the backsheet may be peripherally joined by thermal or other means, and the composition may be injected into the reservoir from a single source or multiple sources if desired.

While particular embodiments of the present invention have been illustrated and described, it will be obvious to those skilled in the art that various changes and modifications may be made without departing from the spirit and scope of the invention, and it is intended to cover in the appended claims all such modifications that are within the scope of the invention.

What is claimed is:

1. An applicator for applying and distributing a skin care composition onto a target skin surface, said applicator comprising:
(a) a substantially planar sheet of compressible, conformable material having a thickness defined by opposed first and second surfaces and an interior region between said first and second surfaces;
(b) at least one discrete reservoir extending inwardly of said first surface into the interior of said sheet of material;
(c) a skin care composition at least partially filling said reservoir; and
(d) at least one discrete aperture formed in said first surface, said aperture being in fluid communication with said reservoir.

2. The applicator of claim 1, wherein said skin care composition comprises:
(i) from about 5% to about 95 wt % of an emollient; and
(ii) from about 5% to about 95 wt % of a thickening agent.

3. The applicator of claim 2, wherein said emollient is a member selected from the group consisting of petroleum-based emollients, fatty acid ester emollients, polysiloxane emollients, sucrose ester fatty acids, alkyl ethoxylates emollients, humectants and mixtures thereof.

4. The applicator of claim 2, wherein the thickening agent is a member selected from the group consisting of polyhydroxy fatty acid esters, polyhydroxy fatty acid amides, C14-C22 fatty alcohols, C12-C22 fatty acids, C12-C22 fatty alcohol ethoxylates, waxes and mixtures thereof.

5. The applicator of claim 2, wherein the skin care composition further comprises a material selected from the group consisting of a skin care ingredient, a suspending agent, and mixtures thereof.

6. The applicator of claim 5, wherein the material comprising a skin care ingredient, and the skin care ingredient is present at a level ranging from about 0.001 to about 70 wt % of the skin care composition.

7. The applicator of claim 5, wherein the skin care ingredient is a member selected from the group consisting of Monograph Category I actives, Monograph Category III actives, enzyme inhibitors, protease inhibitors, chelating agents, anti-microbials, proton donating agents, aloe vera, and mixtures thereof.

8. The applicator of claim 5, wherein the material comprising a suspending agent, and the suspending agent is present at a level ranging from about 0.1 to about 25 wt % of the skin care composition.

9. The applicator of claim 5, wherein the suspending agent is a member selected from the group consisting of treated and untreated fumed silicas, organoclays, derivatives of castor oil, metal fatty acid soaps, calcium silicates, polymeric thickeners, natural or organic thickeners, anionic surfactants, and mixtures thereof.

10. The applicator of claim 1, wherein said applicator includes a plurality of apertures forming a delivery zone adjacent to one end of said applicator.

11. The applicator of claim 1, wherein said reservoir defines an interior volume which decreases when said thickness is reduced by an externally-applied force.

12. The applicator of claim 1, wherein said applicator includes a plurality of apertures and a corresponding plurality of reservoirs, each of said apertures being in fluid communication with one of said reservoirs.

13. The applicator of claim 1, wherein said aperture fully penetrates said first and second surfaces and said reservoir is formed between said second surface and a backing sheet peripherally joined thereto.

14. The applicator of claim 1, wherein said reservoir extends inwardly of said first surface into the interior of said sheet of material but does not penetrate said second surface.

15. The applicator of claim 1, wherein said reservoir extends inwardly of said first surface into the interior of said sheet of material a distance which is less than said thickness.

16. The applicator of claim 1, wherein said sheet material is resilient in compression.

17. The applicator of claim 1, wherein said sheet material is resilient in bending.

18. The applicator of claim 1, wherein said sheet material comprises a closed-cell foam material.

19. The applicator of claim 1, wherein said applicator includes a removable cover sheet for enclosing said aperture prior to use.

20. The applicator of claim 1, wherein said applicator includes a plurality of reservoirs and a corresponding plurality of apertures, and wherein said reservoirs include multiple diverse skin care compositions.

21. The applicator of claim 1, wherein said reservoir is a slot type reservoir.

22. The applicator of claim 1, wherein said reservoir is an aperture-channel type reservoir.

23. The applicator of claim 1, wherein said reservoir is an aperture-channel type reservoir positioned diagonally at a 45° angle.

24. The applicator of claim 1, wherein said reservoir has an aspect ratio from about 1 to about 5.

25. An applicator for applying and distributing a skin care composition onto a target skin surface, said applicator comprising:
(a) a substantially planar sheet of compressible, conformable material having a thickness defined by opposed first and second surfaces and an interior region between said first and second surfaces, said thickness decreases when said sheet of material is subjected to an externally-applied force in a direction substantially normal to said first surface;
(b) at least one discrete reservoir extending inwardly of said first surface into the interior of said sheet of material;
(c) a skin care composition at least partially filling said reservoir; and
(d) at least one discrete aperture formed in said first surface, said aperture being in fluid communication with said reservoir;
whereby compression of said sheet of material via an externally-applied force substantially normal to said first surface expresses said composition from said aperture and translational motion of said first surface relative to a target skin surface applies and distributes said composition onto said target skin surface.

26. A method of applying and distributing a skin care composition onto a body surface, said method comprising the steps of:
(a) providing an applicator in the form of a substantially planar sheet of compressible, conformable material having a thickness defined by opposed first and second surfaces and an interior region between said first and second surfaces, at least one discrete reservoir extending inwardly of said first surface into the interior of said sheet of material, a skin care composition at least partially filling said reservoir, and at least one discrete aperture formed in said first surface, said aperture being in fluid communication with said reservoir;
(b) bringing said applicator into contact with a desired body surface;
(c) compressing said applicator by exerting a force upon said applicator over said body surface to express said skin care composition; and
(d) translating said applicator across said body surface to apply and distribute said skin care composition.

27. The method of claim 26, wherein said compressing and translating steps are simultaneously accomplished.

28. The method of claim 26, wherein said applicator is pre-loaded with said skin care composition.

29. The method of claim 26, wherein said method includes the step of removing a protective covering from said aperture prior to said step of bringing said applicator into contact with a body surface.
